(19) United States
(12) Patent Application Publication
(10) Pub. No.: US 2008/0048907 A1
(43) Pub. Date: Feb. 28, 2008

(54) Object direction detection method and apparatus for determining target object direction based on rectified wave phase information obtained from plurality of pairs of receiver elements

(75) Inventors: Mitsuyasu Matsuura, Chiryu-shi (JP); Toshihiro Hattori, Okazaki-shi (JP); Mitsuru Fujita, Toyohashi-shi (JP)

Correspondence Address: HARNESS, DICKEY & PIERCE, P.L.C., P.O. BOX 828, BLOOMFIELD HILLS, MI, 48303, US

(73) Assignees: DENSO Corporation, Kariya-city (JP); Nippon Soken, Inc., Nishio-city (JP)

(21) Appl. No.: 11/895,826

(22) Filed: Aug. 28, 2007

(30) Foreign Application Priority Data
Aug. 28, 2006 (JP) 2006-231084
Jun. 1, 2007 (JP) 2007-147017

(51) Int. Cl. G01S 13/00

(52) U.S. Cl. 342/147

(57) ABSTRACT

A method of detecting a direction of a target object based on received signals from a receiver element section which receives reflected waves comprising probe waves reflected from said target object, wherein said receiver section comprises an array of four receiver elements with at least three of said receiver elements located at respective apexes of a square, said square having a side length that is equal to or greater than half of a wavelength of said probe waves, includes selecting a specific one of said candidate directions based upon respective phase differences of a plurality of pairs of said receiver elements, with said plurality of pairs comprising at least one pair that differs from each of said pairs of receiver elements utilized in deriving said plurality of candidate directions, and deriving said azimuth angle and said altitude angle of said target object.

### CROSS REFERENCE TO RELATED APPLICATION

The present application relates to and incorporates by references Japanese Patent Application No. 2006-231084 filed on Aug. 28, 2006 and No. 2007-147017 filed on Jun. 1, 2007.

### BACKGROUND OF THE INVENTION

1. The Field of the Invention

The present invention relates to a method of detecting the direction of an object by transmitting probe waves and receiving resultant reflected waves from the object, and to an apparatus and program for applying the detection method.

2. Description of the Prior Art

Types of apparatus are known in the prior art for detecting the position of an object by transmitting probe waves such as ultrasonic waves during a fixed interval, receiving the resultant reflected waves from the object at an array of receiver elements, and utilizing the phase differences between the signals received by respective receiver elements to detect the direction of the object.

The term “receiver element” is used herein with the general significance of a device for converting incident waves (ultrasonic waves or electromagnetic waves) into a corresponding electrical signal.

With such a type of apparatus, designating the wavelength of the probe waves as λ, it is has been necessary in the prior art that, unless special measures are taken such as the use of multiple arrays as described in the following, the distance between adjacent receiver elements (more specifically, the distance between respective centers of adjacent receiver elements) must be less than λ/2. The reason for this is that if the distance is not less than λ/2 then spurious directions, i.e., of virtual images, are obtained, so that the actual direction of a target object cannot be uniquely determined.

This will be described referring to FIG. 23. Designating the distance between adjacent receiver elements J1A and J1B as d, and the actual angle of incidence of the received waves with respect to the straight-ahead direction of the array of receiver elements as α₀, then the direction α of the incident waves can be obtained using the following equation (1). Equation (1) can be modified to the form of equation (2) below.

$$\begin{matrix}\frac{2 π}{λ} d sin α = \frac{2 π}{λ} d sin {α}_{0} + 2 n π , & ( 1 ) \\ sin α = sin {α}_{0} + \frac{λ}{d} n . & ( 2 )\end{matrix}$$

If d≧λ/2 then the right side of equation (2) can take a plurality of values from −1˜1. Thus a plurality of estimated directions α are obtained.

For example if the values d=λ, α₀=60° are inserted in equation (2), then with the prior art method, in addition to the correct direction of 60°, a virtual image at a direction of −7.7° is also obtained from the calculation.

However in practice, the diameter of each receiver element must be greater than λ/2, so that it is difficult to make the distance between adjacent receiver elements smaller than λ/2.

By using a pair of receiver element arrays having respectively different receiver element distances, respective sets of detected directions can be obtained from these which contain directions of virtual images. If these two sets of detected directions are matched to one other then the directions of virtual images can be recognized as directions that do not coincide, between the two receiver element arrays. Such a method is described for example in Japanese Patent Application Laid-Open H11-248821 to Umemi, and Japanese Patent Application Laid-Open 2001-318145 and U.S. Patent Application Publication US 2001/0043510 to Yanagida et al.

However with such a type of method, it is necessary to utilize at least two pairs of receiver elements to detect the altitude angle of an object and two pairs of receiver elements to detect the azimuth angle, i.e., a total of at least eight receiver elements. Hence, the apparatus becomes large in scale.

### SUMMARY OF THE INVENTION

It is an objective of the present invention to overcome the above problem of the prior art by providing a direction detection method, with the method being suitable for execution by a computer program, and an object detection apparatus for implementing the direction detection method, whereby the direction of a target object can be detected both for azimuth angle and altitude angle, while erroneous detection of directions due to virtual images can be prevented, without requiring that the apparatus be large in scale.

More specifically, it is an objective of the invention to achieve the above effects while utilizing a receiver element array for receiving reflected probe waves, having no more than four receiver elements, and wherein the distance between adjacent receiver elements is made equal to or greater than half of the wavelength of the probe waves.

To achieve the above objectives, at least three of the four receiver elements are located at respective apexes of a square, with the square having a side length (i.e., distance between respective centers of a pair of adjacent receiver elements on one side) that is equal to or greater than half of the wavelength of the probe waves.

With preferred embodiments of the invention, the array is disposed with two parallel sides of the square oriented horizontally and the remaining pair of sides oriented vertically.

Basically, the method comprises:

(a) a first step, of deriving a plurality of candidate directions, each expressed as combination of an estimated azimuth angle (one of a plurality of azimuth angles that are derived by calculation based on the phase difference between the received signals from a pair of receiver elements located on a first side of the square) and an estimated altitude angle (one of a plurality of azimuth angles that are derived by calculation based on the phase difference between the received signals from a pair of receiver elements located on a second side of the square, at right angles to the first side),

(b) a second step, of examining all of the possible combinations of selecting a specific one of the candidate directions, based upon respective phase differences of received signals from a plurality of pairs of the receiver elements, with the plurality of pairs comprising at least one pair that differs from each of the pairs of receiver elements utilized in deriving the plurality of candidate directions, and

(c) a third step, of deriving the azimuth angle and altitude angle of the target object, based upon results obtained in the second step.

Specifically, due to the fact that the distance between a pair of adjacent receiver elements (as defined above) is not less than the wavelength of the probe waves, a plurality of azimuth angle values and a plurality of altitude angle values are obtained. By combining all possible combinations of pairs of these, a corresponding plurality of candidate directions are obtained, with only one of these being actually that of a target object. However in the second step, different phase difference information is obtained from that of the first step, i.e., phase differences between the receiver elements in one or more pairs of receiver elements that are different from those of the first step (more specifically, which have a different spacing between the receiver elements in a pair, by comparison with those used in the first step). By using this phase difference information obtained in the second step, it becomes possible to eliminate those candidate directions which result from virtual images, thereby enabling the azimuth angle and altitude angle of the target object to be derived in the third step.

Hence with this method, only the minimum necessary number of receiver elements are utilized, while enabling the direction of a target object to be obtained both in azimuth and in altitude, and while also preventing erroneous direction detection caused by virtual images.

According one aspect of the invention, the four receiver elements are disposed at respective apexes of the square, and, designating the plurality of candidate directions derived in the above-described first step as a first candidate direction group, the second step is performed as:

a first substep, of deriving a second candidate direction group as a plurality of candidate directions, each of which is a combination of an estimated azimuth angle and estimated altitude angle (as described above for the first step), with respective pluralities of azimuth angle and altitude angle values being calculated based on a phase difference between received signals from a first pair of diagonally opposing receiver elements and a phase difference between received signals from a second pair of diagonally opposing receiver elements (i.e., oriented at right angles to the first pair),

a second substep, in which a plurality of candidate direction-pairs are derived, with each candidate direction-pair being a combination of two candidate directions respectively selected from the first and second candidate direction groups (with all of the possible pair combinations being obtained), then calculating the respective values of direction difference between the candidate directions in each of these pairs, and

a third substep, of selecting the candidate direction-pair having the smallest direction difference (since ideally, the directions in the candidate direction-pair the correspond to an actual target object should coincide).

One direction of that pair can then be arbitrarily determined as being the actual target object direction, or alternatively, the average of that pair of candidate directions can be determined as the actual target object direction

This aspect of the invention utilizes the fact that the distance between a pair of “same-side” pair of receiver elements, i.e., as measured along a side of the square, is different from the distance between a pair of diagonally opposing receiver elements. This renders it possible to derive a first set of candidate directions (using received signals corresponding to same-side pairs of receiver elements) and a second set of candidate directions (using received signals corresponding to diagonally opposing pairs of receiver elements), with the virtual image directions that are obtained from the first set of candidate directions being different from those obtained from the second set of candidate directions. Hence, by comparing these two sets of candidate directions, the virtual image directions can be eliminated, as described above.

It thereby becomes unnecessary to utilize a plurality of arrays of receiver elements for achieving that objective, as is required in the prior art, so that the invention enables the number of receiver elements to be minimized.

To increase the reliability of detection, such a method can be modified to ensure that in the event that there are zero or a plurality of candidate direction-pairs for which the above-described direction difference is below a predetermined threshold value, then it is determined that direction detection has not been achieved.

The basic features of such a method of direction detection will be summarized referring to the 3-dimensional (x,y,z) coordinate system shown in FIG. 29, in which a receiver element array is located at the origin of the coordinate system, oriented parallel to the x-y (vertical) plane and with the sides of the aforementioned square oriented respectively horizontally and vertically. Directions are measured from the origin of the coordinate system. Designating the coordinates of a position Pᵢ with respect to the x-y plane as (dxᵢ, dyᵢ), the wavelength of the probe waves as λ, the altitude angle of the direction of reflected waves that are incident on the position Pᵢ as θ, the azimuth angle of that direction (i.e., amount of angular displacement from the z-axis direction, within the horizontal x-z plane) as φ, and the phase of the incident reflected waves attaining the position Pᵢ (measured with respect to a reference phase defined at the origin of the coordinate system) as rᵢ, then rᵢ can be obtained from the following equation (3). In addition, the phase difference ΔΦ_{i,j} between respective incident reflected waves that are incident on an arbitrary pair of positions Pᵢ, Pⱼ can be obtained from the following equation (4).

$$\begin{matrix}{r}_{i} = - \frac{2 π}{λ} ( {dx}_{i} sin ϕcos θ + {dy}_{i} sin θ ) , & ( 3 ) \\ {ΔΦ}_{i , j} = {r}_{i} - {r}_{j} = - \frac{2 π}{λ} [ ( {dx}_{i} - {dx}_{j} ) sin ϕcos θ + ( {dy}_{i} - {dy}_{j} ) sin θ ] . & ( 4 )\end{matrix}$$

From another aspect, instead of utilizing an array having all four receiver elements located at respective apexes of a square, a 4-element receiving array may be utilized in which one of the receiver elements is located at a position within the plane of the square, displaced from an apex (i.e., one apex is left empty). Such a displaced receiver element is referred to herein as a singular receiver element. In that case, the above-described second step comprises:

a first substep of calculating a plurality of candidate judgment values respectively corresponding to the plurality of candidate directions derived in the first step, by successively inserting each of the candidate directions into a specific equation, with a judgment value (in the event that the corresponding candidate direction is an actual object direction) being derived as a hypothetical phase difference, with the term “hypothetical phase difference” signifying the phase difference between hypothetical reflected waves which are incident at the position of the empty apex and the reflected waves which are incident on the singular receiver element,

a second substep of calculating the value of the hypothetical phase difference based on respective phase differences of a plurality of pairs of the receiver elements, with at least one of the plurality of pairs comprising the singular receiver element, and

a third substep of comparing each of the candidate judgment values with the hypothetical phase difference value calculated in the second substep, and selecting the candidate direction for which the corresponding judgment value is closest to that calculated hypothetical phase difference value.

With such a method, by locating one of the receiver elements at a position spaced apart from an apex of the square, with the remaining three receiver elements located on respective remaining apexes of the square, it becomes possible to obtain a greater amount of phase difference information from the received signals of the receiver elements, by comparison with the method in which all four of the receiver elements are located at respective apexes. Such an arrangement of receiver elements is shown in FIGS. 14A and 14B. In that example, a pair of receiver elements (E1, E2) are positioned on respective apexes of an x-direction (i.e., horizontal) side of the square, a pair of receiver elements (E2, E4) are positioned on respective apexes of a y-direction (i.e., vertical) side of the square, and the fourth (singular) receiver element E3 is at a position displaced from the remaining apex (referred to in the following as the empty apex). Designating the center of the square as the origin of the x, y, z coordinate system, the amount of offset of the receiver element E3 from the empty apex along the x-axis direction as Dx, and along the y-axis as Dy, designating the direction of incident reflected waves reaching the receiver element array as (φₖ, θₖ), and designating the estimated difference between the phase of waves incident on the empty apex and the phase of waves that are incident on the singular receiver element (when estimated by using the values φₖ, θₖ expressing some specific direction) as the candidate judgment value ΔΦ(φₖ, θₖ) corresponding to that specific direction, candidate judgment values corresponding to various different directions can each be calculated from the following equation (5):

$${ΔΦ}_{k} ( {ϕ}_{k} , {θ}_{k} ) = \frac{2 π}{λ} ( - {D}_{x} sin {ϕ}_{k} cos {θ}_{k} + {D}_{y} sin {θ}_{k} ) . \qquad ( 5 )$$

When such a judgment value is calculated based on an obtained direction that results from a virtual image, then that judgment value will differ from the actual phase difference (referred to herein as the hypothetical phase difference) between waves that are incident on the empty apex and those which are incident on the singular receiver element. This fact is used to discriminate between an actual direction of a target object and such false directions of virtual images.

Specifically, designating the respective positions of the four receiver elements E1 to E4, disposed as described above and shown in FIGS. 14A and 14B, as P1, P2, P3, P4, the values of phase difference between reflected waves that are incident on each of a pair of receiver elements can be obtained for the six possible receiver element pairs, i.e., as a phase difference ΔΦ_{i,j}, by applying the following equations (6)˜(11):

$$\begin{matrix}{ΔΦ}_{1 , 2} = - {ΔΦ}_{2 , 1} = - \frac{2 π}{λ} [ d sin ϕcos θ ] , & ( 6 ) \\ {ΔΦ}_{2 , 4} = - {ΔΦ}_{4 , 2} = - \frac{2 π}{λ} [ d sin θ ] , & ( 7 ) \\ {ΔΦ}_{1 , 4} = - {ΔΦ}_{4 , 1} = - \frac{2 π}{λ} [ d sin ϕcos θ + d sin θ ] , & ( 8 ) \\ {ΔΦ}_{1 , 3} = - {ΔΦ}_{3 , 1} = - \frac{2 π}{λ} [ {D}_{x} sin ϕcos θ + ( d + {D}_{y} ) sin θ ] , & ( 9 ) \\ {ΔΦ}_{3 , 4} = - {ΔΦ}_{4 , 3} = - \frac{2 π}{λ} [ ( d + {D}_{x} ) sin ϕcos θ - {D}_{y} sin θ ] , & ( 10 ) \\ {ΔΦ}_{2 , 3} = - {ΔΦ}_{3 , 2} = - \frac{2 π}{λ} [ - ( d + {D}_{x} ) sin ϕcos θ + ( d + {D}_{y} ) sin θ ] . & ( 11 )\end{matrix}$$

The hypothetical phase difference will be designated in the following as ΔΦₑₓₚ and can be obtained by combining results from specific ones of the above equations (6)˜(11) to obtain an expression of the same form as the right side of equation (5) above. That is to say, as can be understood from equation (5), the hypothetical phase difference can be expressed as (2π/λ)(−Dₓ sin φₖ cos θₖ+D_{y} sin θₖ), where φₖ and θₖ are the actual azimuth angle and altitude angle of the incident reflected waves. Thus for example, the hypothetical phase difference ΔΦₑₛₚ can be obtained from the following equation (12):
ΔΦₑₓₚ=ΔΦ_{3,2}+ΔΦ_{1,2}+ΔΦ_{4,2}. (12)

As a result, when the above method is implemented by an apparatus, the hypothetical phase difference ΔΦₑₛₚ can be obtained based on respective measured phase differences between the received signals produced from three pairs of receiver elements, i.e., the phase difference between the signals from elements E1, E2, the phase difference between the signals from elements E2, E4, and the phase difference between the signals from elements E2, E3.

Hence, the calculated direction whose corresponding candidate judgment value is closest to (i.e., ideally is identical to) the hypothetical phase difference ΔΦₑₛₚ can be selected as being the direction of an actual target object, with the remaining estimated directions being eliminated

The respective sequences of steps and substeps variously described above can be advantageously implemented as operations performed by a microcomputer in accordance with a computer program, or may be performed by a combination of logic circuits. The above features and further features of the invention may be clearly understood by referring to the following description of preferred embodiments.

### BRIEF DESCRIPTION OF THE DRAWINGS

Other objects and the features of the present invention will become more apparent from the following detailed description of the preferred embodiment taken in conjunction with the accompanying drawings in which:

FIG. 1 is a block diagram showing the overall configuration of an object detection apparatus;

FIG. 2 is a diagram for describing an array of receiver elements in the apparatus of FIG. 1;

FIGS. 3A to 3D are diagrams for describing an array of receiver elements in the apparatus of FIG. 1;

FIG. 4A and FIG. 4B are respective block diagrams of a first candidate direction generating section and a second candidate direction generating section of a first embodiment;

FIG. 5A and FIG. 5B are graphs respectively showing an example of a first candidate direction group and of a second2 candidate direction group, with the directions expressed as points within a 2-dimensional space;

FIG. 6 is a flow diagram of processing executed by a direction determining section in the first embodiment;

FIG. 7 is a graph for use in describing a determination logic employed by the direction determining section of the first embodiment;

FIG. 8 is a block diagram showing a first candidate direction generating section of a second embodiment;

FIG. 9 is a flow diagram of processing executed by a direction determining section in a third embodiment;

FIG. 10 is a flow diagram of processing executed by a direction determining section in a fourth embodiment;

FIG. 11 is a flow diagram of processing executed by a direction determining section in a fifth embodiment;

FIG. 12A and FIG. 12B are block diagrams respectively showing the overall configurations of two alternative embodiments of an object detection apparatus;

FIG. 13 is a block diagram showing the overall configuration of sixth embodiment of an object detection apparatus;

FIG. 14A and FIG. 14B are diagrams showing an arrangement of elements in an array of receiver elements;

FIG. 15 is a block diagram showing a hypothetical phase difference generating section of the sixth embodiment;

FIG. 16 is a flow diagram of processing executed by the hypothetical phase difference generating section in the sixth embodiment;

FIG. 17 is a flow diagram of processing executed by a direction determining section in a seventh embodiment;

FIGS. 18A and 18B are block diagrams respectively showing the overall configurations of two alternative embodiments of an object detection apparatus;

FIG. 19 is a flow diagram of processing executed by a direction determining section in an eighth embodiment;

FIG. 20 is a flow diagram of processing executed by a direction determining section in a ninth embodiment;

FIG. 21 is a flow diagram showing details of processing for deriving a first candidate direction group, in an initial step of the flow diagram of FIG. 5; and

FIG. 22 is a flow diagram showing details of processing for deriving a second candidate direction group, in the initial step of the flow diagram of FIG. 5;

FIG. 23 is a diagram for describing the triangulation method for detecting a target object;

FIG. 24A is a diagram for describing the principle for estimating the direction of the target object using a difference in arrival times by receiving devices;

FIG. 24B is a diagram for describing the principle for estimating the direction of the target object using a difference in phase by receiving devices;

FIG. 25A is a graph representing a relation between a target object direction θ and a difference in phase of the reflected wave Δφ at an element spacing: d=0.75λ;

FIG. 25B is a graph representing a relation between a target object direction θ and a difference in phase of the reflected wave Δφ at an element spacing: d=0.5λ;

FIG. 26A is a front view showing an ultrasonic microphone for use in an ultrasonic sensor;

FIG. 26B is a right side view showing the ultrasonic microphone;

FIG. 26C is a rear view showing the ultrasonic microphone;

FIG. 27 is a vertical sectional view taken along a line A-A in FIG. 26A;

FIG. 28A is a graph illustrating a relation between a resonant frequency and a diameter of an ultrasonic sensor;

FIG. 28B is a graph illustrating relations between a resonant frequency and a diameter of an ultrasonic sensor depending on the thicknesses of a vibrating portion of the ultrasonic sensor; and

FIG. 29 is a diagram for describing definitions of directions, and for describing the operation of a position conversion section.

### DETAILED DESCRIPTION OF THE PREFERRED EMBODIMENTS

Various embodiments of the present invention will now be described hereafter with references to accompanying drawings.

### First Embodiment

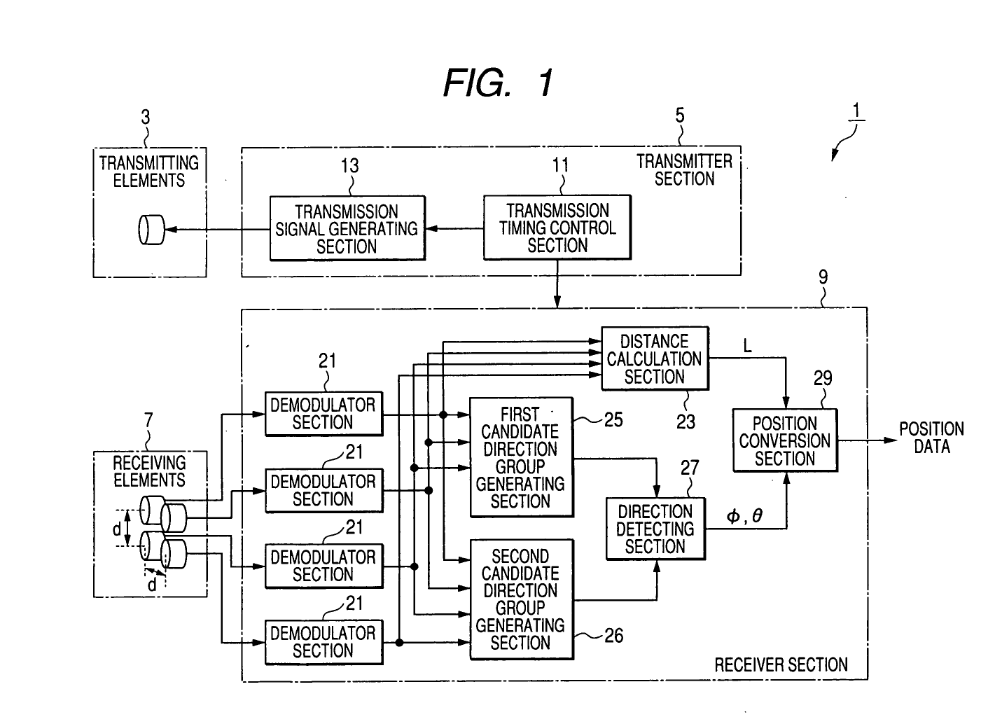

FIG. 1 is a block diagram showing the overall configuration of a first embodiment, which is an object detection apparatus 1. The object detection apparatus 1 transmits pulses of ultrasonic waves and receives resultant reflected ultrasonic wave pulses from an object to obtain received signals, and generates position data expressing the location of the object within three dimensions, based on the received signals.

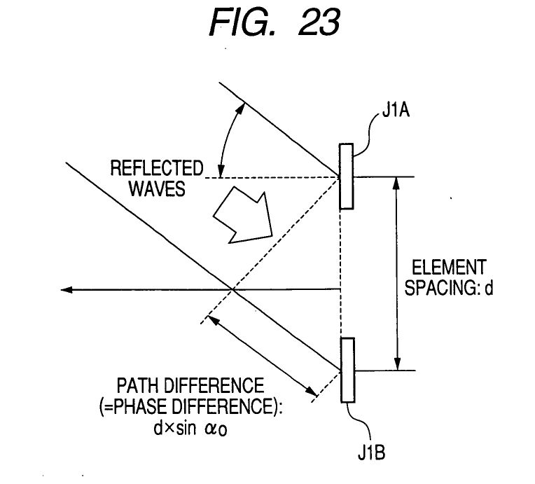

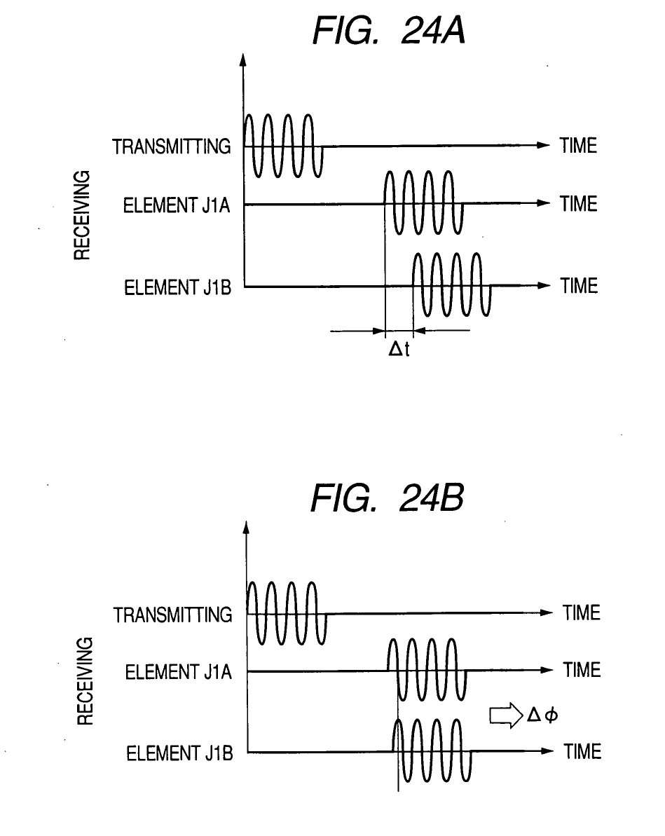

In this type of the direction detecting apparatuses, an operating principle for detecting the target obstacle direction in which the target object is located uses so called the triangulation method schematically described in FIG. 23. In this triangulation method for detecting a target object located on a two-dimensional plane, a transmitting wave such as a radio wave, an ultrasonic wave, and the like is transmitted towards possible directions in which it is expected that the target object exists from the direction detecting apparatus. If the target object exists in a direction, a reflected wave from the target object can be received by two receiving devices 1A and 1B in FIG. 23. The two receiving devices are arranged to be located with a predetermined spacing d. Thus, as shown in FIG. 24A, there is a difference in arrival times Δt which is defined as a difference in time between a time when the reflected wave from the target object can be detected by the receiving device 1A and a further time when the reflected wave from the target object can be detected by the receiving device 1B in FIG. 23, respectively. The difference in arrival times Δt depends on the target object direction in which the target object exists. The target object direction is expressed by an angle θ which is formed the target object direction with a perpendicular direction to a line on which the receiving devices 1A and 1B are located. In the followings, the angle θ is sometimes called as the target object direction for simplicity. If the difference between the arrival times Δt can be measured, a difference of the paths which run from the target object to the receiving devices 1A and 1B is given by

$$Δ t \times \frac{c}{d} , \qquad ( 13 )$$

where c is a velocity of a searching wave, i.e., if an ultrasonic wave is used as the searching wave, c is the sound velocity, d is the predetermined spacing between the receiving devices 1A and 1B. Therefore, the target object direction θ is given by

$${sin}^{- 1} ( Δ t \times \frac{c}{d} ) . \qquad ( 14 )$$

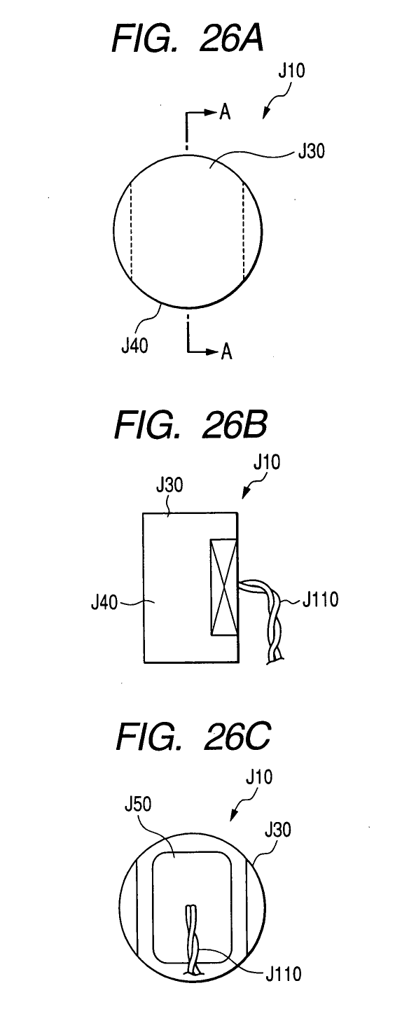

Furthermore, a distance to the target object can also be measured, if a traveling time Δt between a transmitting time when the searching wave is transmitted and a receiving time when the reflected wave is detected by at least one of the receiving devices is measured. However, in this method for detecting the target object direction θ, it is needed to measure the times when the front of the reflected wave from the target object is accurately measured. Due to the industrial requirement of the downsizing of the apparatus for use, the predetermined spacing d between the receiving devices tends to become small. Hence, since the sound velocity c is constant, as the smaller the predetermined spacing d is, the smaller the difference between the arrival times Δt is. Further, if an ultrasonic wave is used as the searching wave, it is difficult to measure the difference between the arrival times Δt since the ultrasonic wave is sensitive to noise and nonlinearity of a medium such as air into which the ultrasonic wave propagates. Then, it becomes to be difficult to accurately measure the difference between the arrival times Δt even in the above mentioned two-dimensional case. In the realistic case, it is necessary to determine the target object direction in three dimension where the target object direction is parameterized by at least two-parameters, as shown in FIG. 26.

There is another method for estimating the target object direction θ. As shown in FIG. 24B, the target object direction θ is obtained from a difference in phase of the reflected wave Δφ between a phase of the reflected wave at a position where the receiving device 1A is located and a further phase of the reflected wave at a further position where the receiving device 1B is located. Let the wave length of the reflected wave, which equals the wave length of the searching wave, λ, the target object direction θ is given by

$${sin}^{- 1} [ \frac{Δϕ \times λ}{2 π d} ] , \qquad ( 15 )$$

where Δφ is the difference in phase of the reflected wave between those detected by the receiving devices 1A and 1B, and d is the predetermined spacing between the receiving devices 1A and 1B. Therefore, even if the difference Δt between the arrival times at which the front of the reflected wave reaches positions where the receiving devices 1A and 1B are located can not be measured, and only the difference in phase of the reflected wave Δφ between those detected by the receiving devices 1A and 1B can be measured, it is possible to obtain the target object direction θ through the above mathematical formula (15).

In the methods for detecting the target object direction based on the difference in phase of the reflected wave Δφ between those detected by the receiving devices, it is occurred that in order to obtain the target object direction θ uniquely, there is necessity for setting the predetermined spacing d between the receiving devices so as to be smaller than the half of the wave length λ of the searching wave.

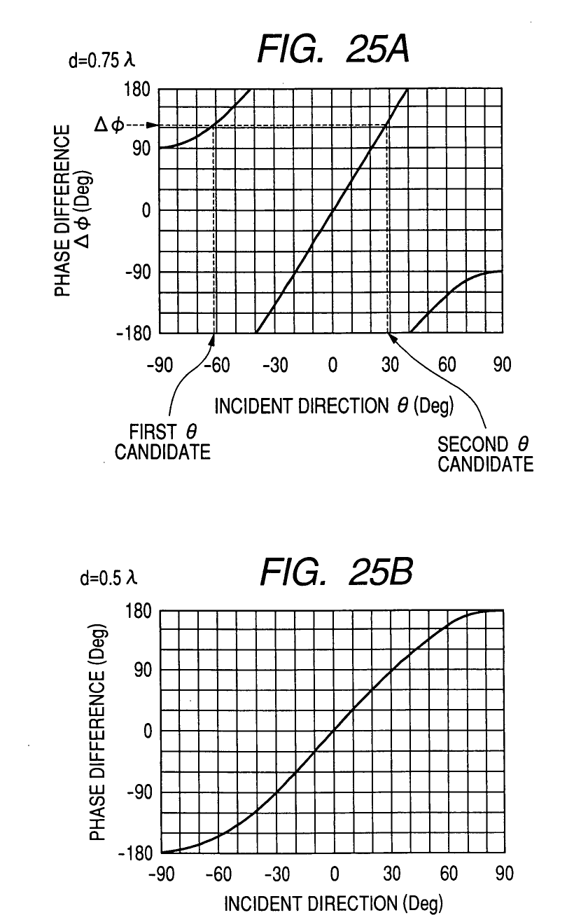

FIG. 25A illustrates a graph representing a relation between a target object direction θ and a difference in phase of the reflected wave Δφ between those detected by the receiving devices, in the case where the predetermined spacing d is set to 0.75λ which is larger than the half of the wave length λ. It can be seen from FIG. 25A that in some region of the difference in phase of the reflected wave Δφ, concretely in the region between 90 degrees and 180 degrees, a plurality of the target object directions θ are corresponded to a difference in phase of the reflected wave Δφ. That is, the target object direction θ does not have an uniquely dependence on the difference in the measured phases of the reflected wave Δφ in the region between 90 degrees and 180 degrees. In FIG. 25A, two possible values of the target object direction θ₁ and θ₂ are found for a given difference Δφ in the measured phases of the reflected wave. Therefore, the target object direction θ is not determined.

FIG. 25B illustrates a graph representing a relation between a target object direction θ and a difference in phase of the reflected wave Δφ between those detected by the receiving devices, in the case where the predetermined spacing d is set to 0.5λ. As can be seen in FIG. 25B, the target object direction θ is a single valued function of the phase of the reflected wave Δφ. Hence, a value of the phase of the reflected wave Δφ is measured, the target object direction θ is uniquely determined.

In more detail, as shown in FIG. 23, let the predetermined spacing between the receiving devices d, a measured target object direction θ₀ from which the reflected wave of the searching wave from the target object is reached, and a estimated target object direction θ which is formed by the target object direction with a perpendicular direction to a line on which the receiving devices 1A and 1B are located, these quantities are satisfied the following equation;

$$\frac{2 π}{λ} d \times sin θ = \frac{2 π}{λ} d \times sin {θ}_{0} + 2 n π , \qquad ( 16 )$$

where n is an integer. From the equation (16), the following mathematical expression is obtained;

$$sin θ = sin {θ}_{0} + \frac{λ}{d} n . \qquad ( 17 )$$

It can be seen from the mathematical expression (16), if the predetermined spacing between the receiving devices d and the wave length of the searching wave λ are satisfied a relation d≧0.5λ, there is a plurality of integers n such that the right hand side of the mathematical expression (16) can take values from −1 to +1. This fact leads to a result that a plurality of expected values of the target object direction θ are obtained. The larger the predetermined spacing between the receiving devices d, the larger the number of the expected values of the target object direction θ.

For example, let d=1.0λ and θ=60°, the target object direction θ is obtained as θ=60° and θ=−7.7° from the mathematical expression (16). The former value θ=60° is a realistic result which is a direction in which the target object is really exists, although the latte value θ=−7.7° is an image, that is, a fictitious result.

Therefore, the predetermined spacing d between the receiving devices should be set to be smaller than or equal to 0.5λ so as to be uniquely determine the target object direction θ.

However, there have existed only receiving devices whose diameter is larger than the half of the wave length λ and it is difficult to manufacture a receiving device whose diameter is smaller than the half of the wave length λ.

An ultrasonic sensor is frequently used as a receiving device. One of the reasons of the difficulty of making an ultrasonic sensor whose diameter is smaller than the half of the wave length λ will be described.

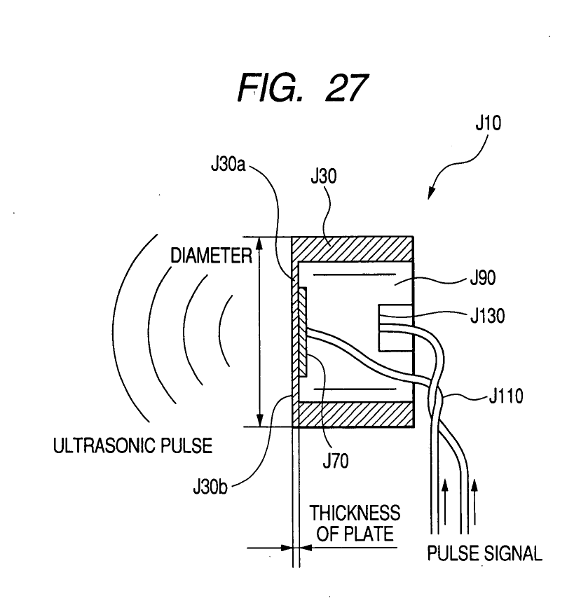

FIG. 26A is a front view showing an ultrasonic microphone J10 for use in an ultrasonic sensor, FIG. 26B is a right side view showing the ultrasonic microphone J10, and FIG. 26C is a rear view showing the ultrasonic microphone J10. FIG. 27 is a vertical sectional view taken along a line A-A in FIG. 26A.

The ultrasonic microphone J10 in FIGS. 26A to 27 is included in the ultrasonic sensor which may be suitably used for the target object direction detecting apparatus.

As shown in FIG. 27, the ultrasonic microphone J10 has a piezoelectric member J70 and a hollow housing J30. The hollow housing member J30 accommodates the piezoelectric member J70 and the like therein. The hollow housing member J30 is inserted by a pinching member J50, as shown in FIG. 26C. The pinching member J50 is made of, for example, felt and silicon rubber. The hollow housing member J30 is provided with the pinching member J50 in the case shown in FIGS. 26A to 26C. FIG. 27 shows the ultrasonic microphone J10 in the case where the pinching member J50 is detached.

As shown in FIG. 27, the hollow housing member J30 has an inner space J90 therein with a rounded-cuboid shape. It can be seen in FIG. 24B the hollow housing member J30 is provided with a side wall portion J40 which has a cylindrical outer surface, and a vibration portion J30a serving as a vibrating plate. The vibration portion J30a is disposed at a side end of the side wall portion J40 and has a round-shaped outer surface J30b which is called as a vibrating surface J30b. Hereinafter, a front side corresponds to the side where the vibration surface J30b is disposed, and a rear side corresponds to the opposite side to the front side. The piezoelectric member J70 is fixed to an inner surface of the vibration portion J30a by bonding.

The inner surface of the side wall portion J40 of the hollow housing member J30 is notched to form a notch portion J130 as shown in FIG. 27. Two ends of a lead wire J110 are electrically connected to the piezoelectric member J70 and the notch portion J110, respectively, by soldering. Hence, the piezoelectric member J70 is activated by a pulse of electric current through the hollow housing member J30.

A operational principle of the ultrasonic microphone J10 is such that when the pulse of electric current is supplied to the piezoelectric member J70 through the lead wire J110 from an electric supply (not shown) so as to vibrate, the vibration portion J30a resonates with the piezoelectric member J70. Thus, a pulse of an ultrasonic wave is generated.

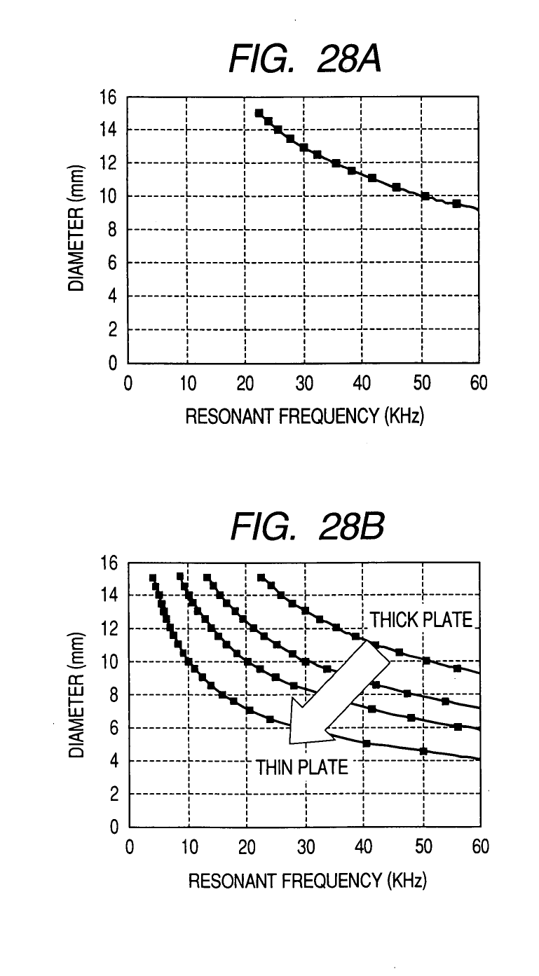

One of methods for arranging a plurality of the microphones J10 so as to be in alignment with a predetermined interval d≦λ/2 includes a step of setting the wave length λ of the ultrasonic wave to as longer as possible. A resonant frequency is defined as an inverse of a wave length λ. Thus, it is preferable that the resonant frequency is as shorter as possible. FIG. 28A shows a fact that as the resonant frequency becomes smaller, that is, the wave length of the ultrasonic wave becomes longer, the diameter of the microphone J10 becomes larger. In other words, the diameter of the microphone J10 is inversely depends on the resonant frequency.

FIG. 28B shows several relationships between the diameter of the microphone J10 and the resonant frequency, each curve corresponding in the case where a given thickness of the vibration portion J30a is selected. It can be seen in FIG. 28A and FIG. 28B that if the thickness of the vibration portion J30a reduced while the diameter of the microphone J10 is kept to be constant, reduction of the frequency of the pulse of the ultrasonic wave can be realized. Thus, it seems that a possibility for arranging the ultrasonic microphones so as to be in alignment with an interval that is shorter than the half of the wave length λ is appeared. However, if the ultrasonic microphone J10 is manufactured such that the vibration portion J30a is made of a thin plate, it becomes to be difficult to keep the sufficient strength of the vibration portion J30a.

From the above mentioned reasons, the diameter of each receiver element must be greater than λ/2, so that it is difficult to make the distance between adjacent receiver elements smaller than λ/2.

(Overall Configuration)

As shown in FIG. 1, the object detection apparatus 1 is made up of a transmitter element 3 for emitting ultrasonic waves as probe waves, a transmitter section 5 for driving the transmitter element to emit the ultrasonic waves modulated as successive pulses (referred to in the following as ultrasonic wave pulses), a receiver element array 7 having four receiver elements E1˜E4 for receiving ultrasonic waves, and a receiver section 9 which generates the position data expressing the location of the object within three dimensions by demodulating and processing received ultrasonic wave pulses that have been emitted from the transmitter element 3. The operation of the receiver section 9 is based on timing signals (described hereinafter) sent from the transmitter section 5.

The transmitter section 5 includes a transmission timing control section 11 which generates timing signals for determining the transmission timings of the ultrasonic wave pulses, and a transmission signal generating section 13 which generates a transmission signal for driving the transmitter element 3 to emit successive ultrasonic wave pulses. The transmission signal is generated by pulse-modulating a carrier signal having an ultrasonic frequency, using a predetermined pulse width (with this embodiment, 250 microseconds) and a predetermined pulse frequency (with this embodiment, 40 kHz), with the ultrasonic wave pulses being generated based on the timing signals from the transmission timing control section 11.

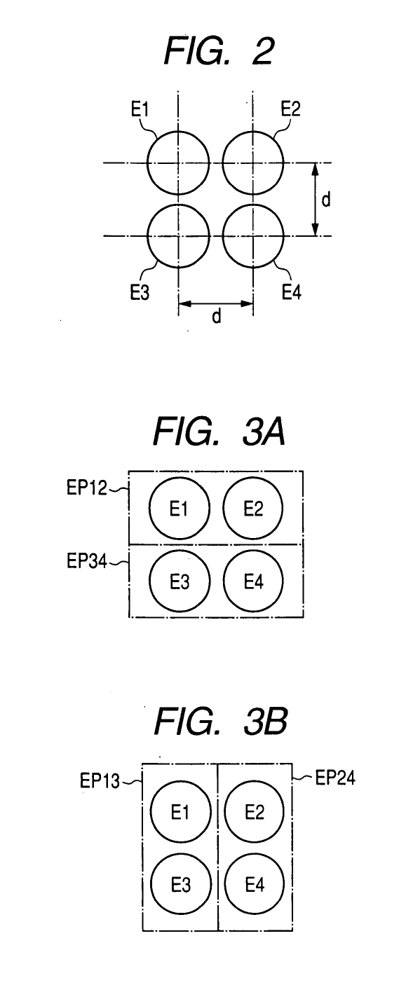

As shown in FIG. 2, the receiver element array 7 has four receiver elements E1˜E4 respectively disposed at the four apexes of a square. Designating the length of each side of the square (i.e., the distance between respective centers of adjacent receiver elements, as measured along the direction of a side of the square) as d, and the wavelength of the ultrasonic wave pulses emitted from the transmitter element 3 as λ, the relationship d≧λ/2 is established. The receiver elements E1˜E4 face in a direction that is normal to the plane of the square, while the orientations of the sides of the square correspond to the horizontal and vertical directions. As viewed from the front of the receiver element array 7, the receiver elements are arrayed with the element E1 at the upper left, element E2 at the upper right, element E3 at the lower left, and E4 at the lower right.

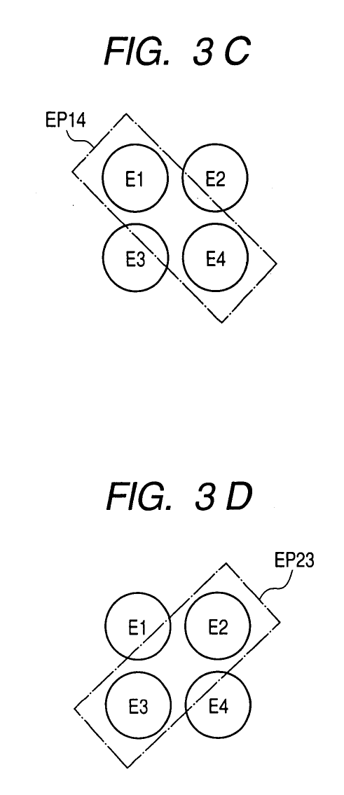

As shown in FIGS. 3A to 3D, the element pair formed of the receiver elements E1, E2 will be designated as EP12, the element pair formed of the receiver elements E3, E4 will be designated as EP34, the element pair formed of the receiver elements E1, E3 will be designated as EP13, the element pair formed of the receiver elements E2, E4 will be designated as EP24, the element pair formed of the receiver elements E1, E4 will be designated as EP14, and the element pair formed of the receiver elements E2, E3 will be designated as EP23. Each of the element pairs EP12, EP34, EP13, EP24 will be referred to as a “same-side pair”, while each of the element pairs EP14, EP23 will be referred to as a “diagonally-opposing pair”.

(Configuration of Receiving Section)

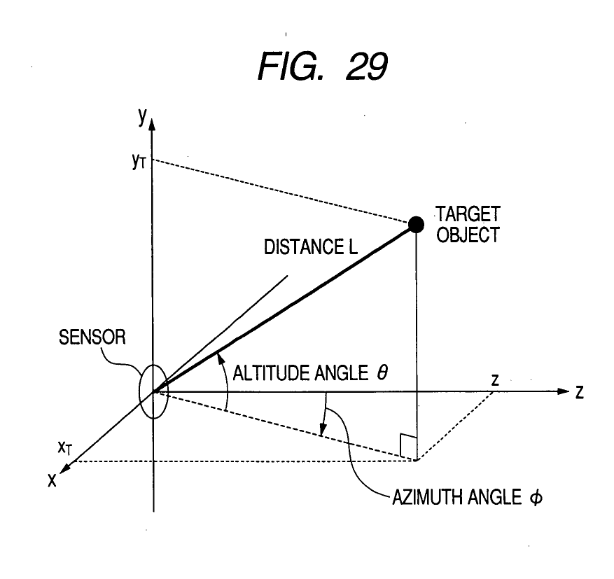

Returning to FIG. 1, the receiver section 9 includes a set of demodulator sections 21 which perform quadrature demodulation of respective received signals from the receiver elements E1˜E4, to generate demodulated signals Ri (where i=1, 2, 3, 4) each formed of I and Q quadrature demodulated signals. The receiver section 9 further includes a distance calculation section 23 which calculates the distance L to an object based upon the demodulated signals R1, R2, R3, R4 from the demodulator sections 21, and a First candidate group generating section 25 which generates a plurality of candidate directions, with each candidate direction expressed as a combination of an estimated azimuth angle φₖ₁ and an estimated altitude angle θₖ₁ (where k1=1, 2, . . . ), where “azimuth angle” and “altitude angle” have the significances defined hereinabove referring to FIG. 29.

The set of candidate directions that are generated by the first candidate group generating section 25 will be referred to as the First group of candidate directions (φₖ₁, θₖ₁), and these are derived by the first candidate group generating section 25 from the demodulated signals R1 to R4 based upon a phase difference between received signals from the same-side element pair EP12, and on a phase difference between received signals from the same-side element pair EP13.

The receiver section 9 further includes a second candidate direction group generating section 26 which generates a second plurality of candidate directions, designated as the second group of candidate directions (φₖ₂, θₖ₂) (where k2=1, 2, . . . ). These are derived by the first candidate group generating section 25 from the demodulated signals R1 to R4, based upon a phase difference between received signals from the diagonally-opposing element pair EP14 and a phase difference between received signals from the diagonally-opposing element pair EP23.

The receiver section 9 also includes a direction determining section 27 which determines an azimuth angle φ and altitude angle θ of the estimated direction of an object based on the first candidate directions and the second candidate directions, and a position conversion section 29. As illustrated in FIG. 29, the position conversion section 29 generates position data (XT, YT, ZT) for the object, based on the distance L of the object as calculated by the distance calculation section 23 and on the azimuth angle φ and altitude angle θ that are determined by the direction determining section 27.

The distance calculation section 23 calculates values of distance based on the time which elapses from a transmission timing (specified by a timing signal) until a receive timing (established from the demodulated signals R1˜R4), and upon the propagation speed of the ultrasonic waves.

Each demodulator section 21 is a known type of circuit, having an A/D converter which converts a received signal to digital signal, quadrature demodulator which performs quadrature demodulation of the digital signals, and a low-pass filter for excluding high-frequency components from the demodulated signals, etc.

First and Second Candidate Direction Pair Group Generating Sections

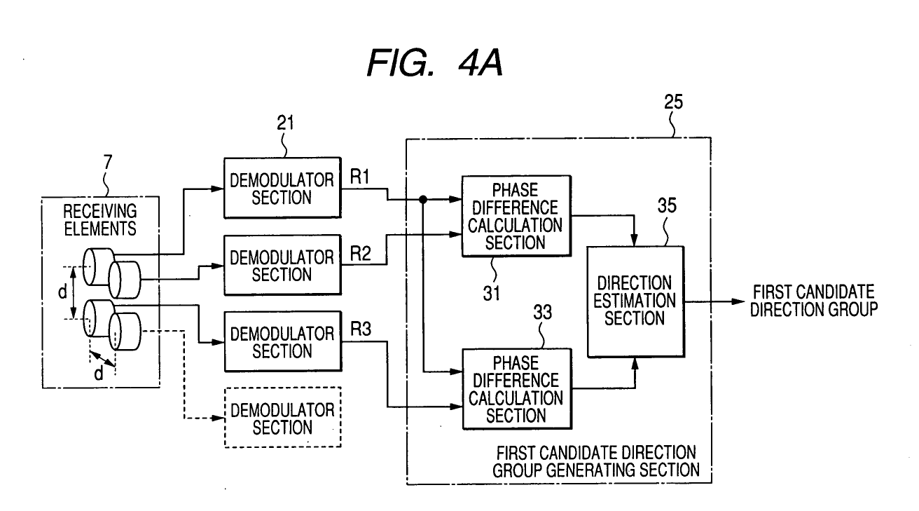

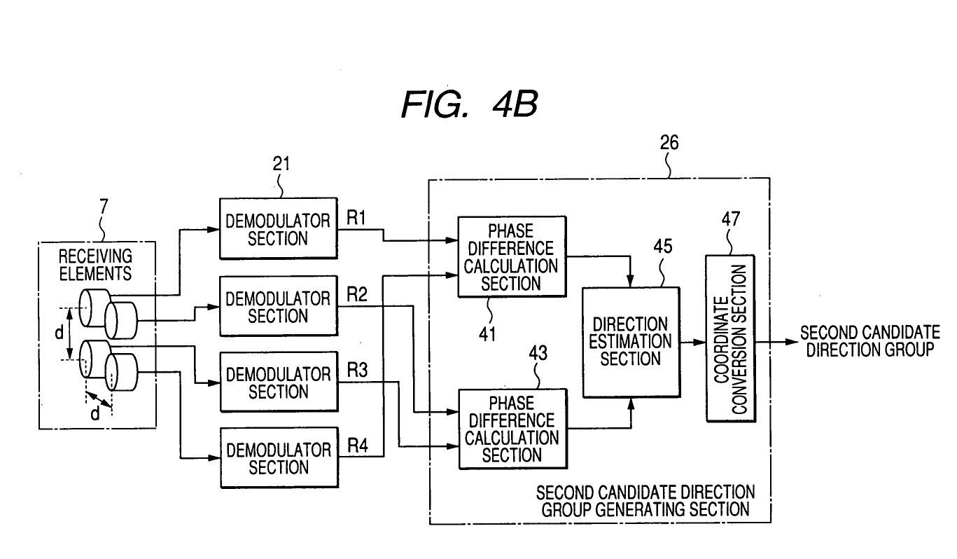

FIG. 4A is a block diagram showing the configuration of the first candidate direction group generating section 25, and FIG. 4B is a block diagram showing the configuration of the second candidate direction group generating section 26. As shown in FIG. 4A, the first candidate group generating section 25 includes a phase difference calculation section 31 which calculates the phase difference ΔΦ_{1,2} between the demodulated signals R1, R2, a phase difference calculation section 33 which calculates the phase difference ΔΦ_{1,3} between the demodulated signals R1, R3, and a direction estimation section 35. The direction estimation section 35 derives one or more azimuth angles from the phase difference ΔΦ_{1,2} and derives one or more altitude angles from the phase difference ΔΦ_{1,3}, and combines these as all of the possible different pairs that are each formed of an azimuth angle and altitude angle, to thereby generate a plurality of estimated object directions. These are outputted by the direction estimation section 35 as the first candidate directions (φₖ₁, θₖ₁).

The direction estimation section 35 uses the following equation (13), obtained by replacing the right-side of equation (1) by ΔΦ, with the azimuth angle designated as φ and the altitude angle designated as θ. By successively inserting each of the phase difference values ΔΦ_{1,2} and ΔΦ_{1,3} (derived as described above) as ΔΦ in equation (18), the corresponding horizontal or altitude angle (φ or θ) is calculated as a value α which is within the range −90°˜90°, as follows:

$$α = {sin}^{- 1} ( \frac{λ}{2 π d} ΔΦ ) . \qquad ( 18 )$$

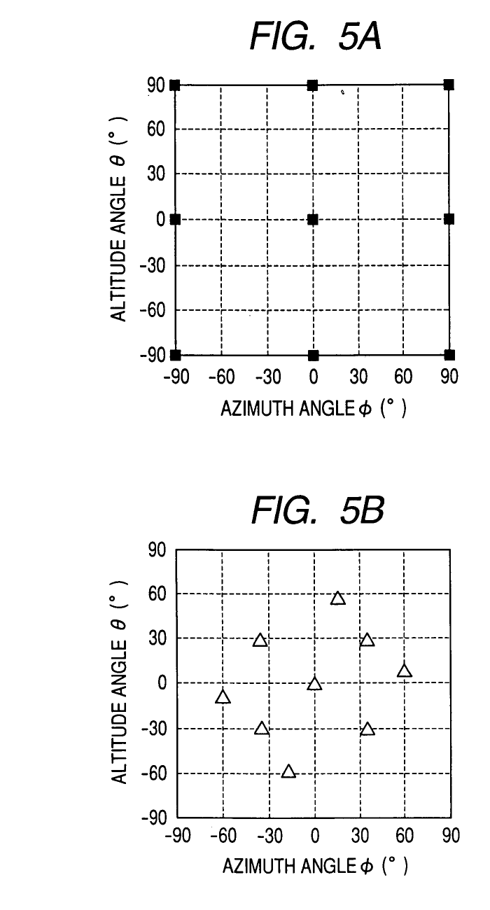

For example, if the receiver element distance d in each same-side element pair is equal to λ, and the phase difference ΔΦ=0, then from equation (18) a set of three azimuth angle values φ are obtained (90°, 0°, +90°), and three altitude angle values θ (90°, 0°, +90°) are also obtained. Thus as indicated by the points in the graph of FIG. 5A, a set of nine candidate directions are derived.

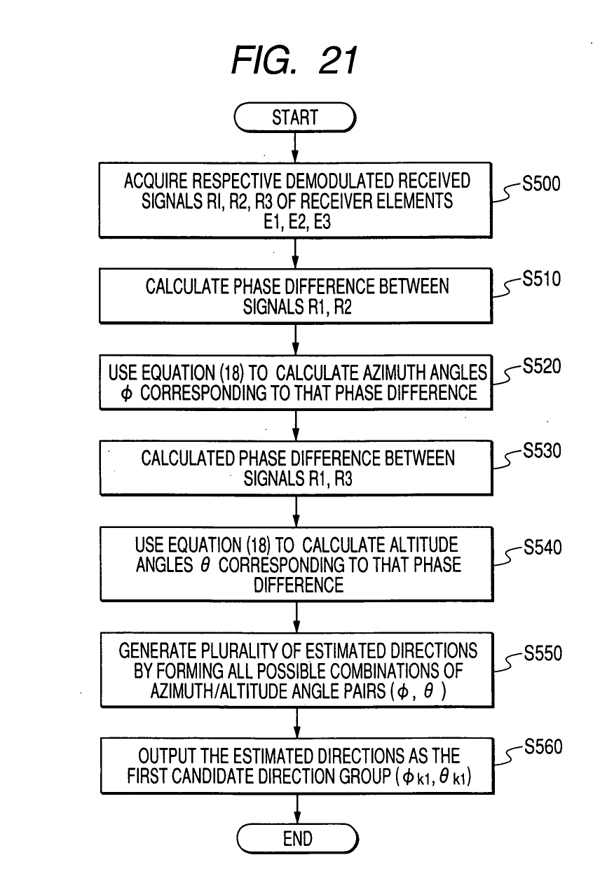

The above processing executed by the first candidate direction group generating section for deriving the first candidate directions can for example be performed in the sequence shown in the flow diagram of FIG. 21.

At step S500, the receiver elements E1˜E3 receive the respective demodulated signals R1˜R3.

Next, at step S510, the phase difference calculating section 31 calculates the phase difference the phase difference ΔΦ_{1,2} between the demodulated signals R1 and R2.

Then, at step S520, the direction estimation section 35 estimates at least one azimuth angles form the phase difference ΔΦ_{1,2} using the equation (18) by substituting ΔΦ in equation (18) with ΔΦ_{1,2}. Equation (18) sometimes outputs a plurality of azimuth angles.

Next, at step S530, the phase difference calculating section 33 calculates the phase difference the phase difference ΔΦ_{1,3} between the demodulated signals R1 and R3. Then, the procedure proceeds to step S540.

At step S540, the direction estimation section 35 estimates at least one altitude angles form the phase difference ΔΦ_{1,3} using the equation (18) by substituting ΔΦ in equation (18) with ΔΦ_{1,3}. Equation (18) sometimes outputs a plurality of altitude angles.

Next, at step S550, the direction estimation section 35 combines the estimated azimuth angles calculated by using equation (18) at step S520 and the estimated altitude angles calculated by using equation (18) at step S540 by forming all possible different pairs wherein each formed of an azimuth angle and an altitude angle so as to generate a plurality of estimated object directions.

Finally, at step S560, the direction estimation section 35 outputs the first candidate directions (φₖ₁, θₖ₁).

The second candidate direction group generating section 26, shown in FIG. 4B, includes a phase difference calculation section 41 which calculates the phase difference ΔΦ_{1,4} between the demodulated signals R1, R4, a phase difference calculation section 43 which calculates the phase difference ΔΦ_{2,3} between the demodulated signals R2, R3, and a direction estimation section 45. The direction estimation section 45 derives estimated object direction components with respect to the array direction of the receiver elements E1, E4 (with that array direction being referred to in the following as the first diagonal direction) based on the phase difference ΔΦ_{1,4}, and derives estimated object direction components with respect to the array direction of the receiver elements E2, E3 (with that array direction being referred to as the second diagonal direction) based on the phase difference ΔΦ_{2,3}. The direction estimation section 45 derives all of the possible different pairs that are each formed of a direction component angle with respect to the first diagonal direction and a direction component angle with respect to the second diagonal direction, to thereby obtain a plurality of estimated object directions relative to a coordinate system that is rotated by 45° from the horizontal/vertical coordinate system. The second candidate direction group generating section 26 further includes a coordinates conversion section 47 which converts estimated object directions generated by the direction estimation section 45 into the horizontal/vertical coordinate system (i.e., that of the direction estimation section 35). The estimated object directions whose coordinates have been converted by the coordinates conversion section 47 are outputted as the second candidate directions (φₖ₂, θₖ₂).

The direction estimation section 45 uses equation (19) below to calculate candidate direction angles α′ with respect to the first diagonal direction, within the range −90° to +90°, by inserting the phase differences ΔΦ_{1,4} as ΔΦ in the equation. For brevity of description, these candidate direction angles α′ obtained with respect to the first diagonal direction will be referred to as the first diagonal angles. Similarly, the direction estimation section 45 calculates candidate direction angles α′ with respect to the second diagonal direction, within the range −90° to +90°, by inserting the phase difference ΔΦ_{2,3} as ΔΦ in the equation. These candidate direction angles α′ obtained with respect to the second diagonal direction will be referred to in the following as the second diagonal angles. The angles α′ are obtained from the following mathematical expression:

$${α}^{′} = {sin}^{- 1} ( \frac{λ}{2 π \sqrt{2} d} ΔΦ ) . \qquad ( 19 )$$

For example, if the element distance d in each same-side element pair equals λ, and the phase difference ΔΦ is 0, then from equation (19), a set of three first diagonal angles (−45°, 0°, +45°), and a set of three second diagonal angles (−45°, 0°, +45°) will be obtained.

The coordinates conversion section 47 converts these three first diagonal angles and three second diagonal angles into the horizontal/vertical coordinate system (i.e., 45° rotation) to obtain three corresponding azimuth angles φ and three corresponding altitude angles θ. As a result, a set of nine (3×3) candidate directions will be obtained as the second candidate direction group in this case, represented as the nine points shown in the graph of FIG. 5B.

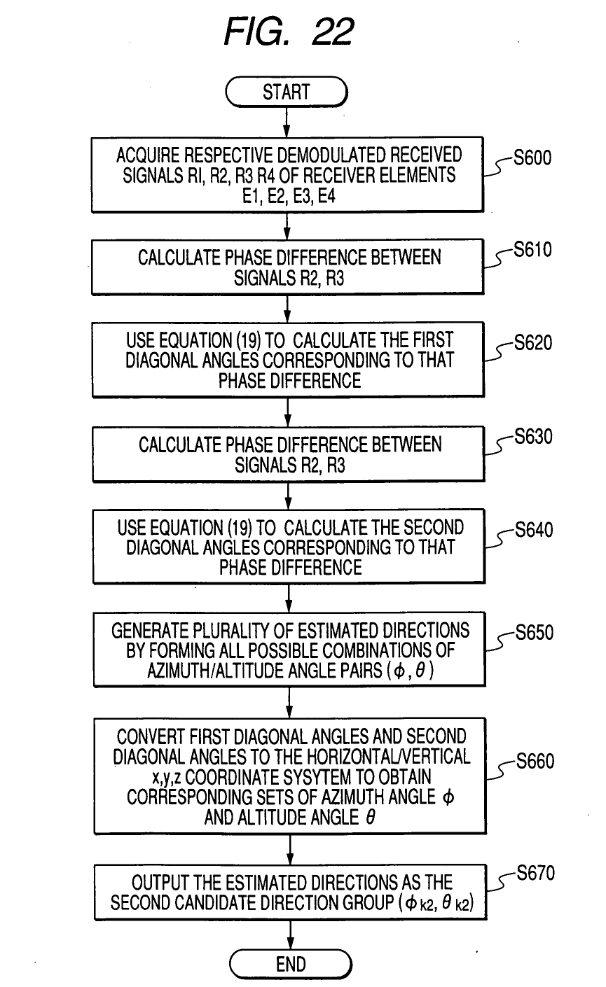

The above processing executed by the second candidate direction group generating section for deriving the second candidate directions can for example be performed in the sequence shown in the flow diagram of FIG. 22.

At step S600, the receiver elements E1˜E4 receive the respective demodulated signals R1˜R4.

Next, at step S610, the phase difference calculating section 41 calculates the phase difference the phase difference ΔΦ_{1,4} between the demodulated signals R1 and R4. Hereafter, this array direction of receiver elements E1 and E4 is referred as EP14 direction that is rotated by 45° from the horizontal/vertical coordinate system, as shown in FIG. 3C.

Then, at step S620, the direction estimation section 45 estimates at least one azimuth angles form the phase difference ΔΦ_{1,4} using the equation (19) by substituting ΔΦ in equation (19) with ΔΦ_{1,4}. Equation (19) sometimes outputs a plurality of azimuth angles.

Next, at step S630, the phase difference calculating section 43 calculates the phase difference the phase difference ΔΦ_{2,3} between the demodulated signals R2 and R3. Hereafter, this array direction of receiver elements E2 and E3 is referred as EP23 direction that is rotated by 45° from the horizontal/vertical coordinate system, as shown in FIG. 3D. Then, the procedure proceeds to step S640.

At step S640, the direction estimation section 45 estimates at least one altitude angles form the phase difference ΔΦ_{1,3} using the equation (19) by substituting ΔΦ in equation (19) with ΔΦ_{1,3}. Equation (19) sometimes outputs a plurality of altitude angles.

Next, at step 650, the direction estimation section 45 combines the estimated azimuth angles calculated by using equation (19) at step S620 and the estimated altitude angles calculated by using equation (19) at step S640 by forming all possible different pairs wherein each formed of an azimuth angle and an altitude angle so as to generate a plurality of estimated object directions (φ, θ). Then, the procedure proceeds to step S660.

At step S660, the coordinate conversion section 47 rotates the plurality of estimated object directions (φ, θ) by 45° in order to correct offset angles due to the facts that the EP 14 and the EP23 direction are rotated by 45° from the horizontal/vertical coordinate system.

Finally, at step S670, the coordinate conversion section 47 outputs the second candidate directions (φₖ₂, θₖ₂).

(Direction Determining Section)

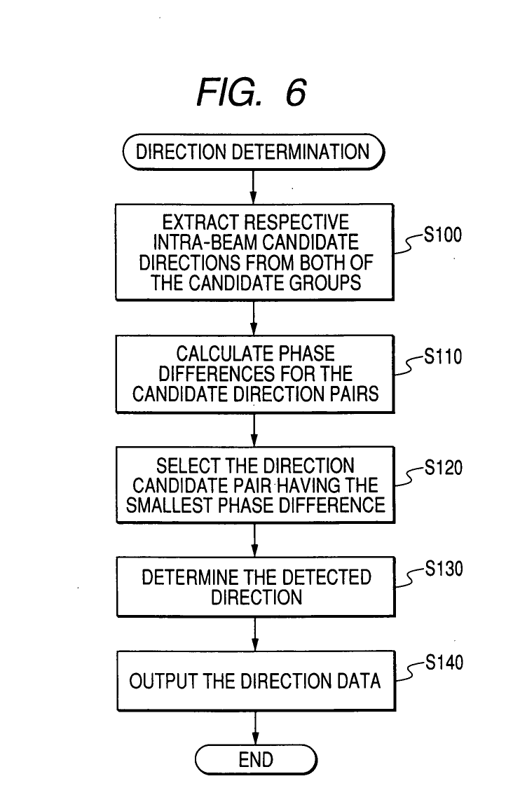

Referring to the flow diagram shown in FIG. 6, the processing executed by the direction determining section 27 to determine the direction of an object, based on the first candidate directions and the second candidate directions generated by the first candidate direction group generating section 25 and the second candidate direction group generating section 26 will be described in the following. This processing is executed each time an ultrasonic wave pulse is transmitted and a first candidate direction group and second candidate direction group are then generated.

An example of a processing sequence for deriving the first candidate direction group, executed by the first candidate direction group generating section 25, is shown in the flow diagram of FIG. 21. A processing sequence for deriving the second candidate direction group, executed by the first candidate direction group generating section 25, is shown in the flow diagram of FIG. 22.

When processing by the direction determining section 27 commences, firstly in step S100 of FIG. 6 all candidate directions that fall outside the receiving beam, i.e., for which either or both of the azimuth angle and altitude angle are outside the half-angle of the array of receiver elements E1˜E4, are eliminated from further processing.

Next, in S110, a plurality of candidate direction-pairs are derived. Each of these is a combination of a candidate direction extracted from the first candidate direction group and a candidate direction extracted from the second candidate direction group, with all of the possible different combinations being utilized. The difference between the constituent directions in each of these candidate direction-pairs is then derived (with that difference corresponding to a candidate direction-pair being referred to in the following simply as the direction difference), for all of the candidate direction-pairs.

Thus for example if each of the selected first and second candidate direction groups is made up of nine directions, then a total of 9×9, i.e., 81 candidate direction-pairs, and a corresponding set of 81 direction differences, will be obtained in step S110.

Each direction difference of a candidate direction-pair can be expressed as a distance measured within a plane that is defined by horizontal-direction and vertical-direction coordinates as shown in FIGS. 5A, 5B for example, i.e., is the distance between the two points that respectively correspond to the two directions which constitute the candidate direction-pair

Next in S120, the candidate direction-pair is selected for which the aforementioned direction difference is the smallest (with that difference being ideally zero, when corresponding to reflected waves from an actual target object). As described above, each candidate direction-pair consists of one direction from the first candidate direction group and one direction from the second candidate direction group. With this embodiment of the two directions constituting the selected candidate direction-pair, the one that is from the first candidate direction group is arbitrarily determined as being the detected direction (φ, θ), in step S130. In step S140, that detected direction (φ, θ) is outputted to the position conversion section 29, and the processing is then ended.

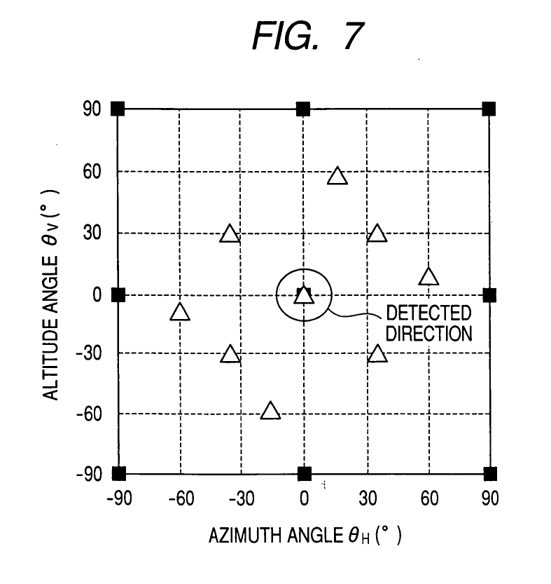

In S130, it is not essential to select the direction that is from the first candidate direction group to be the detected direction (φ, θ). It would be equally possible to select the direction that is from the second candidate direction group, or to calculate the average of the two directions constituting the selected candidate direction-pair, and to determine that average direction as being the detected direction. Hence with the processing of FIG. 6, as illustrated in the example of FIG. 7, the first candidate direction group and second candidate direction group (with the directions expressed as respective points) are superimposed on one another in a plane formed by the horizontal and vertical coordinate axes, and the pair of candidate directions which are closest to one another (i.e., which ideally should coincide) are selected as representing an actual image. while the remaining candidate directions are eliminated as being virtual images.

Effects

As described in the above, with this embodiment, the object detection apparatus 1 has an array of four receiver elements E1 to E4 disposed in a square formation, and utilizes combinations of these as two different types of receiver element pairs (i.e., the same-side element pairs and the diagonally-opposing element pairs), having respectively different values of distance between adjacent elements, and with the two different types of receiver element pairs having respectively different array directions.

As a result the object detection apparatus 1 can perform direction detection for both azimuth and altitude angles, with directions corresponding to virtual images being rejected, while enabling a minimum number of receiver elements to be utilized, even if the distance between centers of adjacent receiver elements is made equal to or greater than half of the wavelength of the probe waves. Hence an appropriate size of receiver element can be employed.

In addition, due to the fact that the phase of received signals is used in direction detection, improved reliability and reduced effects of interference can be achieved, by comparison with methods which employ estimation of directions based upon received signal levels.

### Second Embodiment

A second embodiment will be described in the following. This embodiment differs from the first embodiment only with respect to the configuration of a first candidate group generating section 25a which replaces the first candidate group generating section 25 of the first embodiment, so that the description will be centered on these points of difference from the first embodiment.

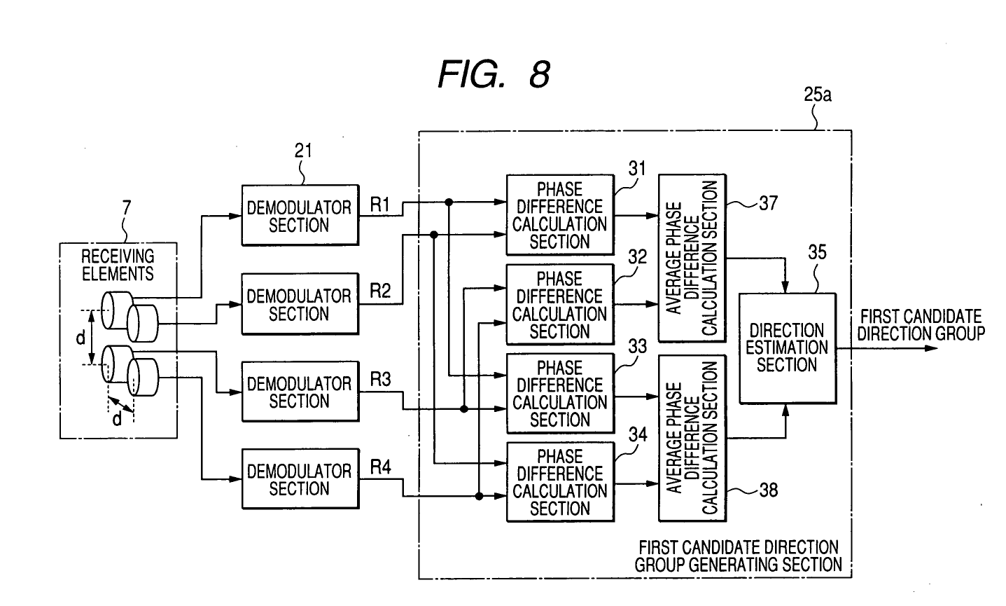

FIG. 8 is a block diagram of the second embodiment. As shown, the first candidate group generating section 25a includes a phase difference calculation section 31 which calculates the phase difference ΔΦ_{1,2} between the demodulated signals R1, R2, a phase difference calculation section 32 which calculates the phase difference ΔΦ_{3,4} between the demodulated signals R3, R4, a phase difference calculation section 33 which calculates the phase difference ΔΦ_{1,3} between the demodulated signals R1, R3, and a phase difference calculation section 34 which calculates the phase difference ΔΦ_{2,4} between the demodulated signals R2, R4. The first candidate group generating section 25a further includes an average phase difference calculation section 37 which calculates the average of the phase differences ΔΦ_{1,2} and ΔΦ_{3,4} and an average phase difference calculation section 38 which calculates the average of the phase differences ΔΦ_{1,3} and ΔΦ_{2,4}.

The first candidate group generating section 25a further includes a direction estimation section 35, which uses the above-described equation (18), inserting the average phase difference calculated by the average phase difference calculation section 37 as ΔΦ), to obtain one or more values α (in this case, each constituting an azimuth angle φ), and uses above-described equation (19), inserting the average phase difference calculated by the average phase difference calculation section 38 as ΔΦ, to obtain one or more values α (in this case, each constituting an altitude angle θ). The direction estimation section 35 then generates a plurality of directions each expressed by a combination of one of the azimuth angles from the average phase difference calculation section 37 and one of the altitude angles from the average phase difference calculation section 38 (i.e., with all of the possible different directions being generated), and outputs the resultant generated directions as the first candidate direction group.

Thus with this embodiment, the phase differences between the signals from the same-side element pair EP12 and the signals from the same-side element pair EP34 (two same-side element pairs having the same array direction) shown in FIGS. 3A to 3D are averaged by the average phase difference calculation section 37, while the phase differences between the signals from the same-side element pair EP13 and the signals from the same-side element pair EP24 (two same-side element pairs having the same array direction) are averaged by the average phase difference calculation section 38.

As a result, with this embodiment, the accuracy of determining the directions expressed by the first candidate direction group can be increased by comparison with the first embodiment. Thus, by selecting the direction that is from the first candidate direction group when performing step S130 described above, the accuracy of the position that is determined by the direction determining section 27 (i.e., the final detected direction) can be increased, so that the accuracy of the resultant position data that are outputted from the position conversion section 29 can be increased.

### Third Embodiment

A third embodiment will be described in the following. This embodiment differs from the first embodiment only with respect to a part of the processing executed by the direction determining section 27, so that the description will be centered on these points of difference from the first embodiment.

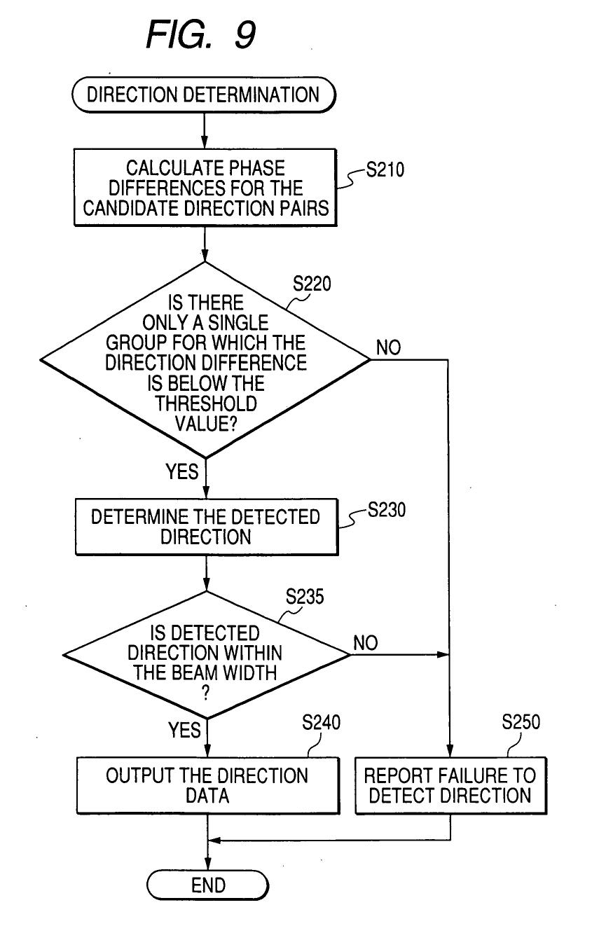

FIG. 9 is a flow diagram of the processing executed by the direction determining section 27 of this embodiment. As shown in FIG. 9, by comparison with the first embodiment, S100 is omitted and S135 and S150 are added.

When processing is started, then firstly in S110, a plurality of candidate direction-pairs are derived. Each of these is a combination of one direction from the first candidate direction group and one direction from the second candidate direction group, i.e., with all of the possible different direction pairs being derived. The amount of difference in direction between the constituent directions in each of these candidate direction-pairs is then derived, for all of the candidate direction-pairs.

Next in S120, the candidate direction-pair is selected for which the aforementioned direction difference is the smallest of all of the candidate direction-pairs. Of the two directions constituting the selected candidate direction-pair, the direction that is from the first candidate direction group is determined as the detected direction (φ, θ), in step S130.

Next in S135, a decision is made as to whether the detected direction thus determined is within the half-angle of the array of receiver elements E1˜E4, i.e., is within the beam width of the receiver element array 7. If the detected direction is within the beam width, then in S140 that detected direction (φ, θ) is outputted to the position conversion section 29, and the processing is then ended.

However if the detected direction is judged to be outside the beam width in S135, then a notification is sent to the position conversion section 29, indicating that direction detection has not been achieved, and the processing is then ended.

Thus with this embodiment, a decision is made as to whether or not the determined detected direction is within the beam width of the receiver element array 7, i.e., is a valid direction. Thus it is possible that when the processing of FIG. 9 is executed, no final determined direction will be obtained, whereas with the first embodiment, a final determined direction is always obtained.

Hence with this embodiment, in addition to the effects obtained with the first embodiment, increased reliability of detection can be achieved.

### Fourth Embodiment

A fourth embodiment will be described in the following. This embodiment differs from the first embodiment only with respect the processing executed by the direction determining section 27, so that the description will be centered on these points of difference from the first embodiment.

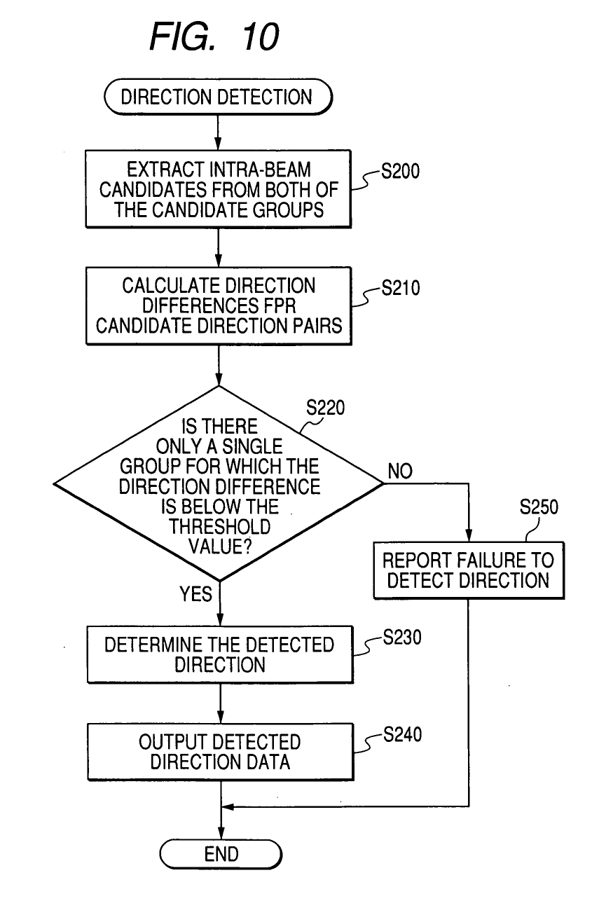

FIG. 10 is a flow diagram of the processing executed by the direction determining section 27 of this embodiment. Firstly in S200, only those directions within the first candidate direction group and second candidate direction group are selected which are within the half-angle of the receiver elements E1˜E4, for both the azimuth and altitude angles, to thereby select only candidate directions that are within the beam width of the receiver element array 7.

Next in S210, a plurality of candidate direction-pairs are derived. Each of these is a combination of one direction from those of the first candidate direction group that have been selected by step S200, and one direction from those of the second candidate direction group that have been selected in step S200, i.e., with all of the possible different direction pairs being derived. The amount of difference in direction between the constituent directions in each of these candidate direction-pairs is then derived, for all of the candidate direction-pairs.

Next in S220, a decision is made as to whether there is only one of these candidate direction-pairs for which the calculated direction difference is below a predetermined threshold value. If there is only a single candidate direction-pair for which that condition is satisfied, then operation proceeds to step S230.

In S230, out of the two directions which form the selected candidate direction-pair, the direction that is from the first candidate direction group is determined as being the detected direction. In step S240, that detected direction is outputted to the position conversion section 29, and the processing is then ended.

However if it is judged in S220 that the number of candidate direction-pairs for which the direction difference is below the threshold value is zero or is a plurality, then operation proceeds to step S250, in which a notification is sent to the position conversion section 29 indicating that direction detection has not been achieved, and the processing is then ended.

Thus with this embodiment, instead of simply determining the detected direction based on the candidate direction-pair having the smallest direction difference as with the previous embodiments, the determination is made only for a candidate direction-pair having a direction difference which is below a predetermined threshold value, and is only made in the event that there is only a single candidate direction-pair which satisfies that condition.

Thus with this embodiment, even if by chance there are candidate direction-pairs in which the constituent directions substantially coincide, but which are produced due to virtual images, such a candidate direction-pair will not be erroneously determined as a detected direction. Thus the reliability of detection is further increased.

### Fifth Embodiment

A fifth embodiment will be described in the following. This embodiment differs from the fourth embodiment only with respect to a part of the processing executed by the direction determining section 27, so that the description will be centered on these points of difference from the fourth embodiment.

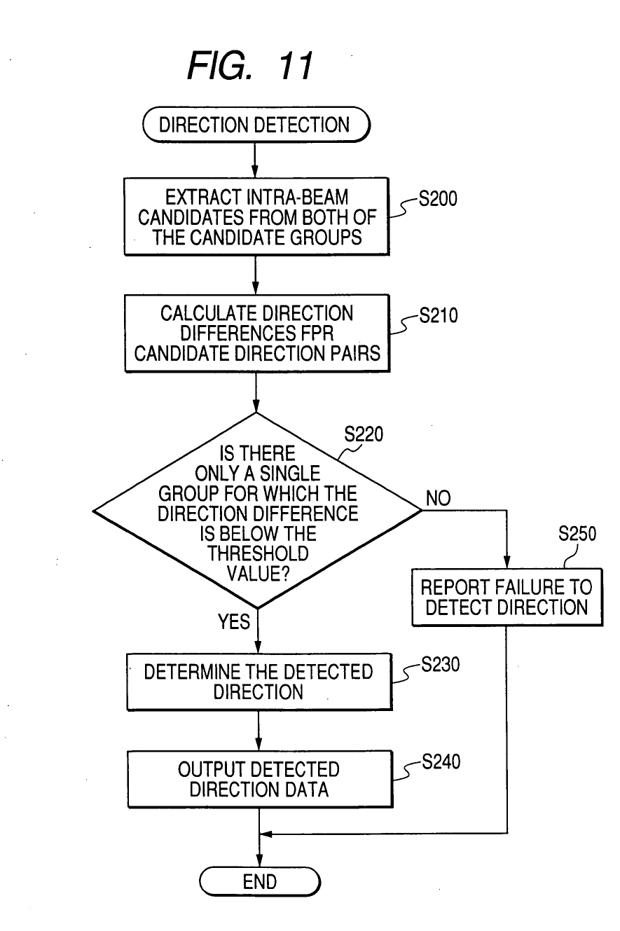

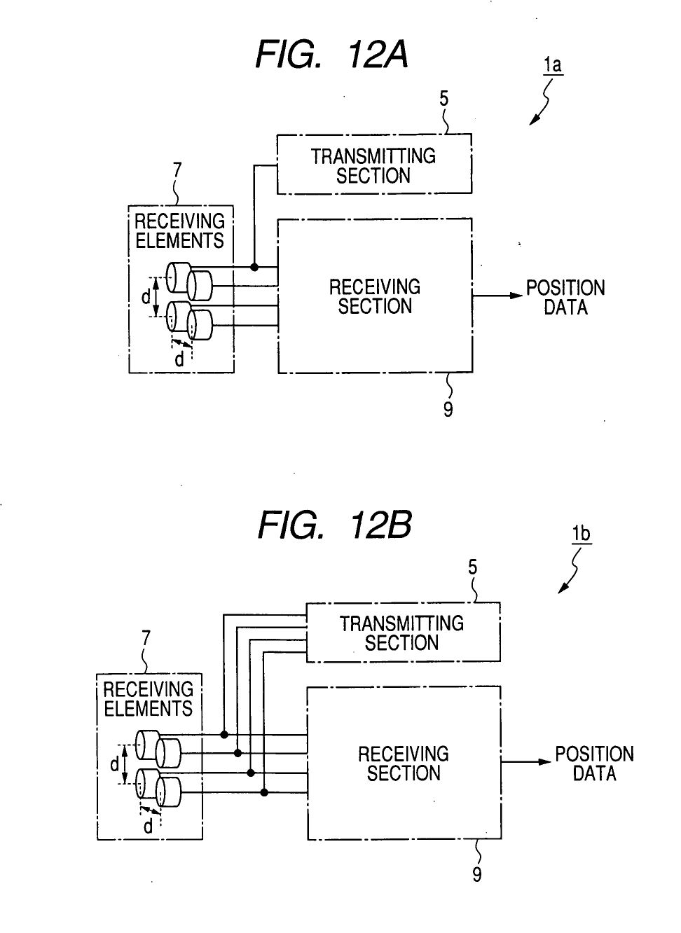

FIG. 11 is a flow diagram of the processing executed by the direction determining section 27 of this embodiment. By comparison with the processing of the fourth embodiment, S200 is omitted and a step S235 is added.

Firstly, when processing is started (S210) a plurality of candidate direction-pairs are derived. Each of these is a combination of one direction from the first candidate direction group and one direction from the second candidate direction group, i.e., with all of the possible different direction pairs being derived. The amount of difference in direction between the constituent directions in each of these candidate direction-pairs is then derived, for all of the candidate direction-pairs.

Next in S220, a decision is made as to whether there is only one of these candidate direction-pairs for which the calculated direction difference is below a predetermined threshold value. If there is only a single candidate direction pair for which that condition is satisfied, then operation proceeds to step S230.

In S230, out of the two directions which form the selected candidate direction-pair, the direction that is from the first candidate direction group is determined as being the detected direction.

Next in S235, a decision is made as to whether the detected direction thus determined is within the half-angle of the array of receiver elements E1˜E4, i.e., is within the beam width of the receiver element array 7. If the detected direction is within the beam width, then in S240 that detected direction is outputted to the position conversion section 29, and the processing is then ended.

However if the detected direction is judged to be outside the beam width in S235, or if it has been found in step S220 that the number of candidate direction-pairs for which the direction difference is below the threshold value is zero or is a plurality, then operation proceeds to step S250, in which a notification is sent to the position conversion section 29 indicating that direction detection has not been achieved, and the processing is then ended.

Thus with this embodiment, a feature of the third embodiment (S235) is combined with a feature (S220) of the fourth embodiment. Hence this embodiment provides further enhanced reliability and accuracy of direction detection.

### Sixth Embodiment

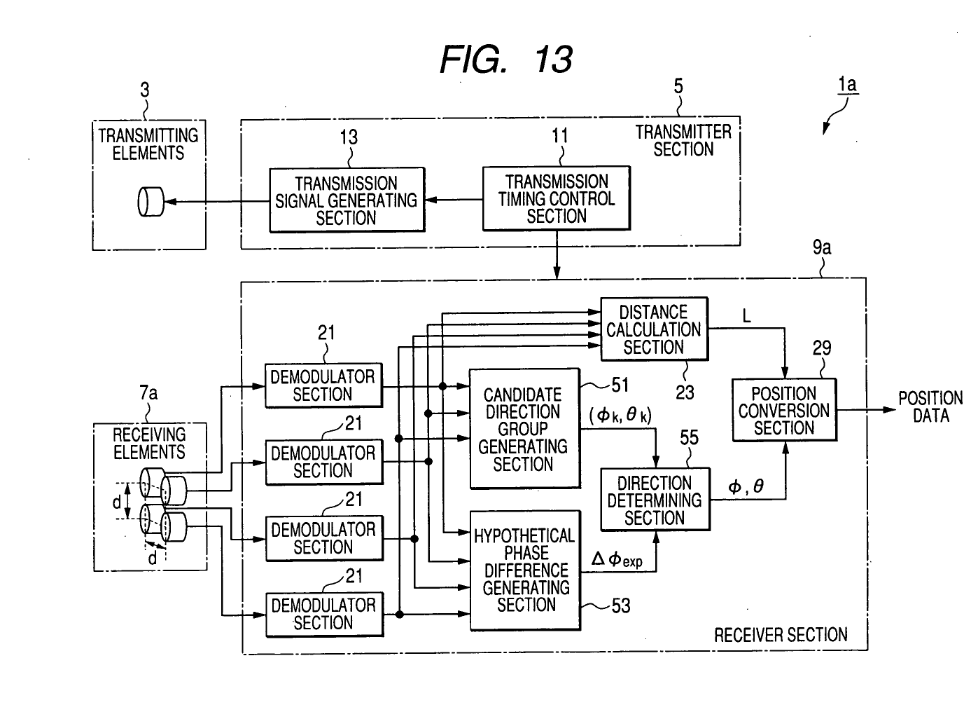

A sixth embodiment will be described in the following referring to FIG. 13, which shows the overall configuration of an object detection apparatus 1a. This embodiment differs from the first embodiment only with respect to a part of the receiver element array 7a and of a receiver section 9a, so that the description will be centered on these points of difference from the first embodiment.

Receiver Element Array Configuration

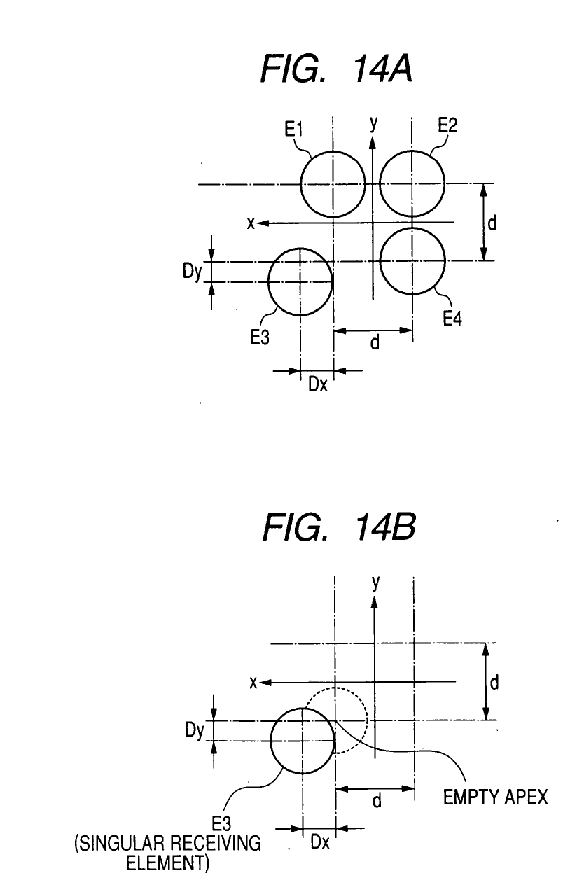

As shown in FIG. 14A, a receiver element array 7a of this embodiment is made up of four receiver elements E1 to E4, with the elements E1, E2, E4 respectively located at corresponding apexes of a square and with the third element E3 being located at a position that is offset from the remaining apex of the square. That is to say, element E3 is located at a position separated from each of the sides of the square and separated from extension lines of these sides.

In the following, the square at which none of the elements E1 to E4 are located will be referred to as the “empty apex”, while the receiver element E3 that is offset from an apex position will be referred to as the “singular receiver element”.

The coordinates of the 3-dimensional space in which the receiver element array 7a is located will be defined as follows. The center of the aforementioned square will be designated as the origin, and the respective directions of orientation of two adjacent sides of the square which are at right angles to one another will be designated as the x-axis and y-axis (vertical) directions. That is to say, as shown in FIG. 11, the receiver element array 7a is located on an x-y plane, with the front of the array facing in the z-axis (straight-ahead) direction, and with the x-z plane being horizontal.

Referring again to FIG. 14A, as viewed from the front, the receiver elements E1˜E4 are arranged with the receiver element E1 at the upper left position, the receiver element E2 at the upper right position, the receiver element E3 at the lower left position, and the receiver element E4 at the lower right position. The positive direction of the x-axis coordinate extends towards the left, while the positive direction of the y-axis coordinate extends upward.

Designating the length of each side of the square (i.e., the distance between centers of adjacent receiver elements other than the singular receiver element E3) as d, and the wavelength of the ultrasonic wave pulses transmitted by the transmitter element 3 as λ, the value of d is set as ≧λ/2.

The degree of offset of the singular receiver element E3 from the empty apex along the x-axis direction is designated as Dx, while the amount of offset along the y-axis direction is designated as Dy, as illustrated in FIG. 14B. Dx and Dy are made respectively different in length.

(Configuration of Receiver Section)

Returning to FIG. 13, the receiver section 9a includes a set of demodulator sections 21, a distance calculation section 23, and a position conversion section 29, as for the first embodiment.

Based on the demodulated signals R1, R2, R3, a candidate direction group generating section 51 in the receiver section 9a derives the phase differences respectively corresponding to the same-side element pairs EP12 and EP24, to thereby generate a plurality of candidate directions (φₖ₁, θₖ₁) each expressed as a combination of an azimuth angle φk and an altitude angle θₖ (where k=1, 2 . . . ). Also in the receiver section 9a, a hypothetical phase difference generating section 53 generates a hypothetical phase difference ΔΦₑₓₚ for the object being detected, by utilizing demodulated signals R1, R2, R3, R4 to derive respective phase differences corresponding to the element pairs EP12, EP24 and the diagonally-opposing element pair EP23.

As described hereinabove, the hypothetical phase difference is the difference between the phase of reflected waves that are incident on the empty peak and the phase of reflected waves that are incident on the singular receiver element E3. Also in the receiver section 9a, a direction determining section 55 determines the direction (φ, θ) of the object based on the candidate directions (φₖ₁, θₖ₁) from the candidate direction group generating section 51 and the hypothetical phase difference ΔΦₑₓₚ from the hypothetical phase difference generating section 53.

The candidate direction group generating section 51 differs from the first candidate group generating section 25 of the first embodiment only in that it operates on the demodulated signal of the receiver element E4 instead of that of the receiver element E3, however in other respects, the configuration and operation are identical to those of the first candidate group generating section 25, so that detailed description is omitted.

(Hypothetical Phase Difference Generating Section)

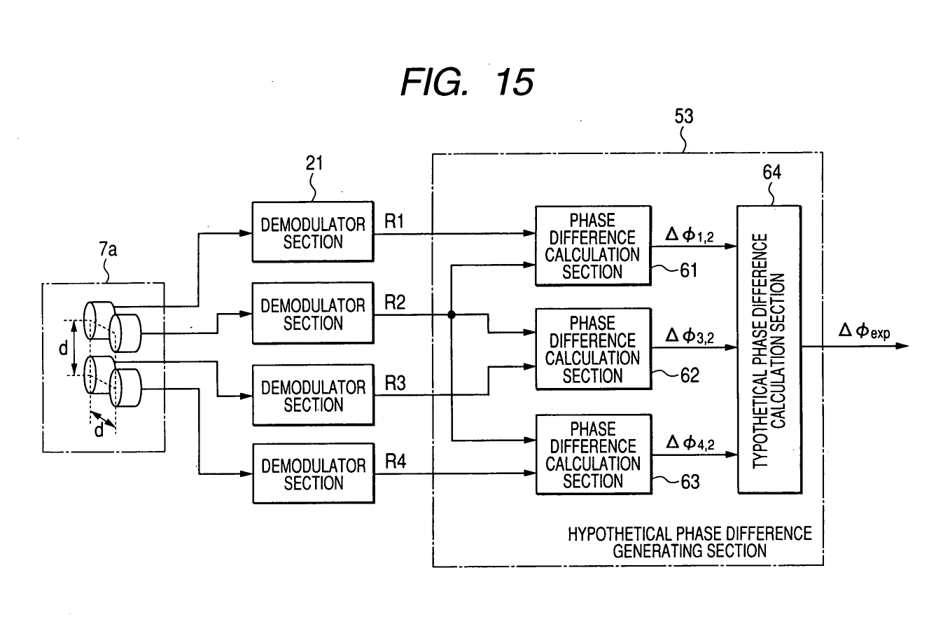

FIG. 15 is a block diagram of the hypothetical phase difference generating section 53. As shown, this includes a phase difference calculation section 61 which calculates the phase difference ΔΦ_{1,2} between the demodulated signals R1 and R2 (see equation (4) above), a phase difference calculation section 62 which calculates the phase difference ΔΦ_{2,3} between the demodulated signals R2 and R3, and a phase difference calculation section 63 which calculates the phase difference ΔΦ_{4,2} between the demodulated signals R4 and R2. The hypothetical phase difference generating section 53 also includes a hypothetical phase difference calculation section 64, which sums these respective phase differences produced from the phase difference calculation sections 61, 62, 63, by using equation (20) below, to thereby calculate the hypothetical phase difference ΔΦₑₓₚ as followings:
ΔΦₑₓₚ=ΔΦ_{3,2}+ΔΦ_{1,2}+ΔΦ_{4,2}. (20)

Equation (20) corresponds to equation (12) whose derivation has been described referring to equations (5) and (6)˜(11). As can be understood from that description, although this embodiment is described for the case of the hypothetical phase difference being calculated as a combination of respective phase differences of received signals from the receiver element pairs (R1, R2), (R2, R3) and (R2, R4), it would be equally possible to utilize other combinations of phase differences of receiver element pairs. The essential point is that at least one of the phase difference values must be obtained from a receiver element pair that includes the singular receiver element E3.

(Direction Determining Section)

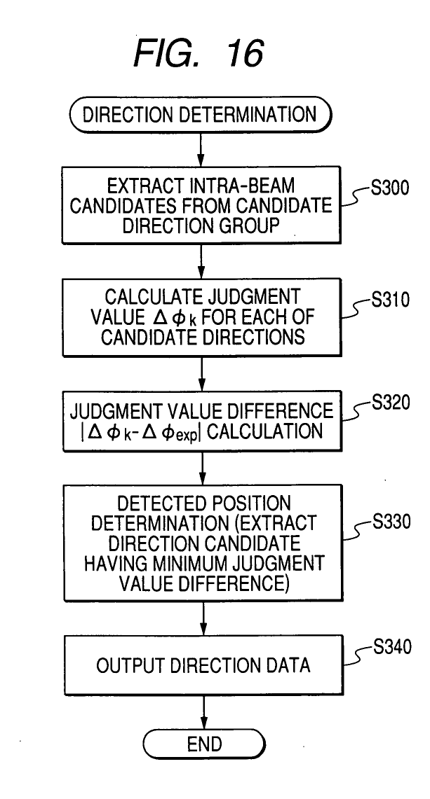

Next, the processing executed by the direction determining section 55 for determining the direction of the object based on the candidate direction (φₖ, θₖ) and the hypothetical phase difference ΔΦₑₓₚ will be described, referring to the flow diagram of FIG. 16. This processing is executed each time an ultrasonic wave pulse is transmitted and a set of candidate directions (φₖ, θₖ) and a hypothetical phase difference ΔΦₑₓₚ are then derived by the candidate direction group generating section 51 and the hypothetical phase difference generating section 53 respectively.

Firstly, in S300, each of the candidate directions (φₖ, θₖ) for which one or both of the azimuth angle φₖ and altitude angle θₖ are outside the receiving beam width of the receiver elements E1˜E4 is excluded from further processing, to select only those candidate directions which are within the beam width.

Next in S310, for each of the selected candidate directions, a judgment value Δ_{Φk} is calculated, by inserting the azimuth angle φₖ and altitude angle θₖ of the candidate direction into the following equation (21). This corresponds to equation (5) described hereinabove, so that (in the case of a candidate direction corresponding to an actual object) the corresponding judgment value will be obtained as the phase difference between reflected waves that are incident on the empty peak and waves that are incident on the singular receiver element E3.

$${ΔΦ}_{k} ( {ϕ}_{k} , {θ}_{k} ) = \frac{2 π}{λ} ( - {D}_{x} sin {ϕ}_{k} cos {θ}_{k} + {D}_{y} sin {ϕ}_{k} ) . \qquad ( 21 )$$

Operation then proceeds to step S320.

In step S320, for each of the selected candidate directions (φₖ, θₖ) the absolute difference

|ΔΦₖ−ΔΦₑₓₚ| between the corresponding candidate judgment value ΔΦₖ and the hypothetical phase difference ΔΦₑₓₚ (supplied from the hypothetical phase difference generating section 53) is calculated, then operation proceeds to step S330. In S330, the candidate direction for which the absolute value |ΔΦₖ−ΔΦₑₓₚ| is a minimum is selected as the detected direction.

Next, in S340, the detected direction is outputted to the position conversion section 29, and the processing is ended.

Hence with this processing, for each of the candidate directions (φₖ, θₖ) obtained from the demodulated signals R1, R2, R4 corresponding to the receiver elements E1, E2, E4, without the signal for the singular receiver element E3, a judgment value ΔΦₖ is obtained which (if the candidate direction is valid) expresses the difference (hypothetical phase difference ΔΦₑₓₚ) between the phase of the reflected waves received at the empty apex and the phase of the reflected waves that are received at the location of the singular receiver element E3.

The candidate direction (φₖ, θₖ) corresponding to the receiver element for which the judgment value ΔΦₖ is closest to the calculated hypothetical phase difference ΔΦₑₓₚ is then found, and that candidate direction is judged to be a real direction of an object, and so is determined as being the detected direction, while the other candidate directions are eliminated as being those of virtual images.

(Effects Obtained)

With this embodiment, the object detection apparatus 1a utilizes a single receiver element (the singular receiver element) E3 that is located with an amount of offset (Dx, Dy) from an empty apex of a square, while the receiver elements E1 E2, E4 are respectively disposed on the remaining three apexes of the square. Candidate directions (φₖ, θₖ) are derived by utilizing signals from the receiver elements E1 E2, E4, with the singular receiver element E3 being excluded. By using the signal from the singular receiver element E3, a real image direction (i.e., direction of an actual object) can be specified from within the candidate directions.

Thus with the object detection apparatus 1a, in the same way as for the object detection apparatus 1 described above, directions can be detected for both azimuth and altitude angles, erroneous detection of spurious directions caused by virtual images can be prevented, while only a minimum number of receiver elements is required, even if the distance between centers of adjacent receiver elements is made equal to or greater than half of the wavelength of the probe waves. Hence an appropriate size of receiver element can be employed.

Furthermore with the object detection apparatus 1a, in the same way as for the object detection apparatus 1, since direction detection is performed by using received signal phase, enhanced reliability and accuracy of direction detection can be achieved, by comparison with methods employing direction estimation based on received signal levels

### Seventh Embodiment

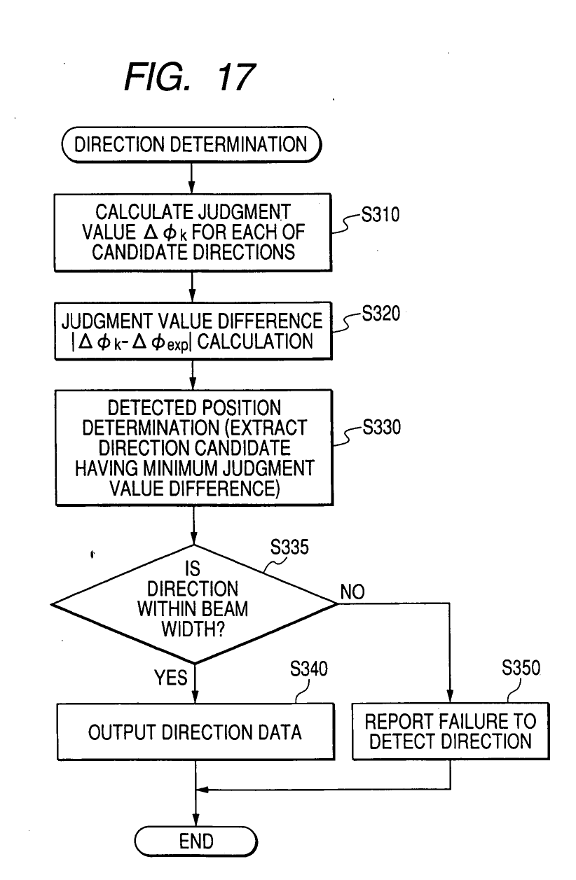

A seventh embodiment will be described in the following. This embodiment differs from the sixth embodiment only with respect to a part of the processing executed by the direction determining section 55 of the object detection apparatus 1a, so that the description will be centered on these points of difference from the sixth embodiment. FIG. 17 is a flow diagram of the processing executed by the direction determining section 55 of this embodiment. By comparison with the processing of the sixth embodiment, step S300 is omitted and S335, S350 are added.

When the processing is started, then firstly in S310 (as described for the sixth embodiment), a judgment value ΔΦₖ is calculated for each of the candidate directions (φₖ, θₖ) that are supplied from the candidate direction group generating section 51. Operation then proceeds to step S320.

In step S320, for each of the selected candidate directions (φₖ, θₖ), the absolute difference |ΔΦₖ−ΔΦₑₓₚ| between the corresponding candidate judgment value ΔΦₖ and the hypothetical phase difference ΔΦₑₓₚ (produced from the hypothetical phase difference generating section 53) is calculated, then operation proceeds to step S330. In S330, the candidate direction for which the absolute value |ΔΦₖ−ΔΦₑₓₚ| is a minimum is selected as the detected direction. Operation then proceeds to step S335.

In step S335, a decision is made as to whether the candidate direction that has been selected as the detected direction in S320 is within the receiving beam. If it is within the receiving beam, then operation proceeds to step S340 in which the detected direction is outputted to the position conversion section 29, and the processing is then ended.

However if the detected direction is judged to be outside the receiving beam in S335, then operation proceeds to step S350, in which a notification is sent to the position conversion section 29 indicating that direction detection has not been achieved, and the processing is then ended.

Thus with this embodiment, the judgment as to whether a direction is within the receiving beam is not made upon each of the candidate directions (as is done with the sixth embodiment), but instead, the judgment is made on the detected direction. Hence, failure to achieve direction detection may occur.

This embodiment provides the same effects as for the sixth embodiment, while increasing the reliability of direction detection.

### Eighth Embodiment

An eighth embodiment will be described in the following. This embodiment differs from the sixth embodiment only with respect to the processing executed by the direction determining section 55 of the object detection apparatus 1a, so that the description will be centered on these points of difference from the sixth embodiment.

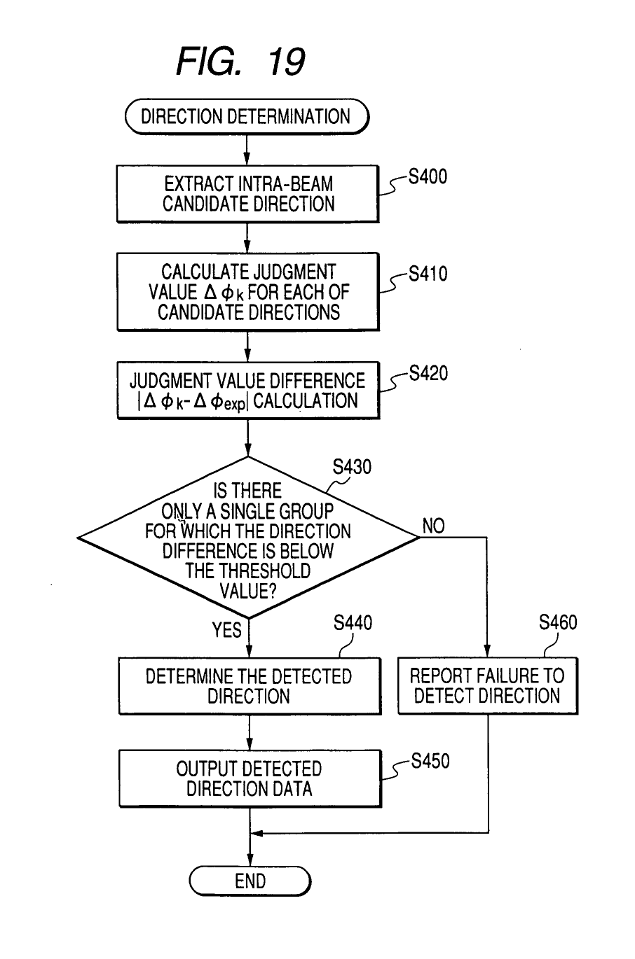

FIG. 19 is a flow diagram of the processing executed by the direction determining section 55 of this embodiment. Firstly in S400, each of the candidate directions (φₖ, θₖ) for which one or both of the azimuth angle θₖ and altitude angle θk are outside the half-angle of the receiver elements E1˜E4 is excluded from further processing, to select only those candidate directions which are within the receiving beam width. Operation then proceeds to step S410.

In step S410, a judgment value ΔΦₖ is calculated (as described hereinabove) for each of the candidate directions (φₖ, θₖ) that have been selected in step S400. Next in step S420, the absolute difference |ΔΦₖ−ΔΦₑₓₚ| between a candidate judgment value ΔΦₖ and a hypothetical phase difference ΔΦₑₓₚ is calculated, for each of the judgment values.

In the following step S430, a decision is made as to whether there is only one of the selected candidate directions for which the absolute difference |ΔΦₖ−ΔΦₑₓₚ| is below a predetermined threshold value. If there is only a single candidate direction for which that condition is satisfied, then operation proceeds to step S440, in which that candidate direction is determined as being the detected direction. In step S450, that detected direction is outputted to the position conversion section 29, and the processing is then ended.

However if it is judged in S430 that the number of candidate directions for which the direction difference is below the threshold value is zero or is a plurality, then operation proceeds to step S460, in which a notification is sent to the position conversion section 29 indicating that direction detection has not been achieved, and the processing is then ended.

Thus with this embodiment, instead of determining the detected direction only as the candidate direction for which the difference with respect to the judgment value is a minimum (i.e., for which |ΔΦₖ−ΔΦₑₓₚ| is a minimum) as with the seventh embodiment, with the eighth embodiment the detected direction is determined as being a candidate direction for which both of the conditions are satisfied that:

(a) the judgment value difference |ΔΦₖ−ΔΦₑₓₚ| is below a predetermined threshold value, and also

(b) it is the only candidate direction for which condition (a) is satisfied.

As a result, the possibility of erroneous direction detection due to virtual images can be reduced, and the reliability of direction detection thereby increased.

### Ninth Embodiment

A ninth embodiment will be described in the following. This embodiment differs from the eighth embodiment only with respect to part of the processing executed by the direction determining section 55 of the object detection apparatus 1a, so that the description will be centered on these points of difference from the eighth embodiment.

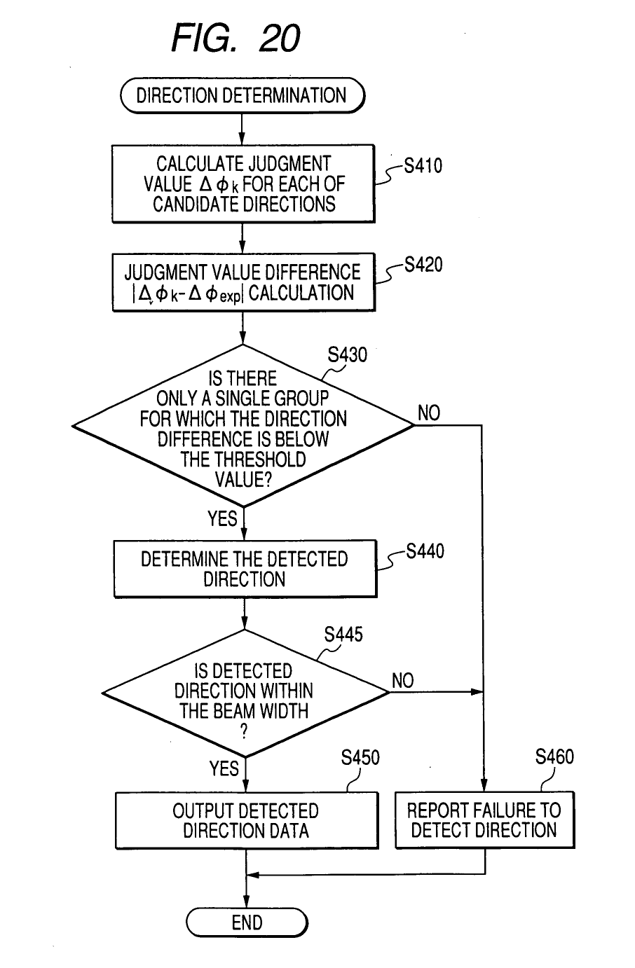

FIG. 20 is a flow diagram of the processing executed by the direction determining section 55 of this embodiment. By comparison with that for the eighth embodiment, step S400 is omitted and S445 is added. Firstly in step S410, a judgment value ΔΦₖ is calculated (as described hereinabove) for each of the candidate directions (φₖ, θₖ) supplied from the candidate direction group generating section 51. Next in s420 the absolute difference |ΔΦₖ−ΔΦₑₓₚ| between the judgment value ΔΦk and hypothetical phase difference ΔΦₑₓₚ is calculated, for each of the judgment values. Operation then proceeds to step S430.

In S430, a decision is made as to whether there is only one of the selected candidate directions for which the calculated difference |ΔΦₖ−ΔΦₑₓₚ| is below a predetermined threshold value. If there is only a single candidate direction for which that condition is satisfied, then operation proceeds to step S440, in which that candidate direction is determined as being the detected direction.

S445 is then executed, in which a decision is made as to whether the determined detected direction is within the receiving beam of the receiver elements E1˜E4. If it is with the receiving beam, then step S450 is executed in which the determined detected direction is outputted to the position conversion section 29, and the processing is then ended.

However if it is judged in S430 that the number of candidate direction-pairs for which the direction difference is below the threshold value is zero or is a plurality, or if it is found in step S445 that the determined detected direction is outside the receiving beam, then step S460 is executed, in which a notification is sent to the position conversion section 29 indicating that direction detection has not been achieved, and the processing is then ended.

Thus this embodiment combines a feature (S445) of the seventh embodiment with a feature (S430) of the eighth embodiment, and as a result, further increase in detected direction accuracy and reliability are achieved.

It should be noted that although the above embodiments have been described for the case of ultrasonic waves being emitted by the transmitter element 3 for scanning an object, the invention is equally applicable to use with electromagnetic waves as probe waves.

### Other Embodiments

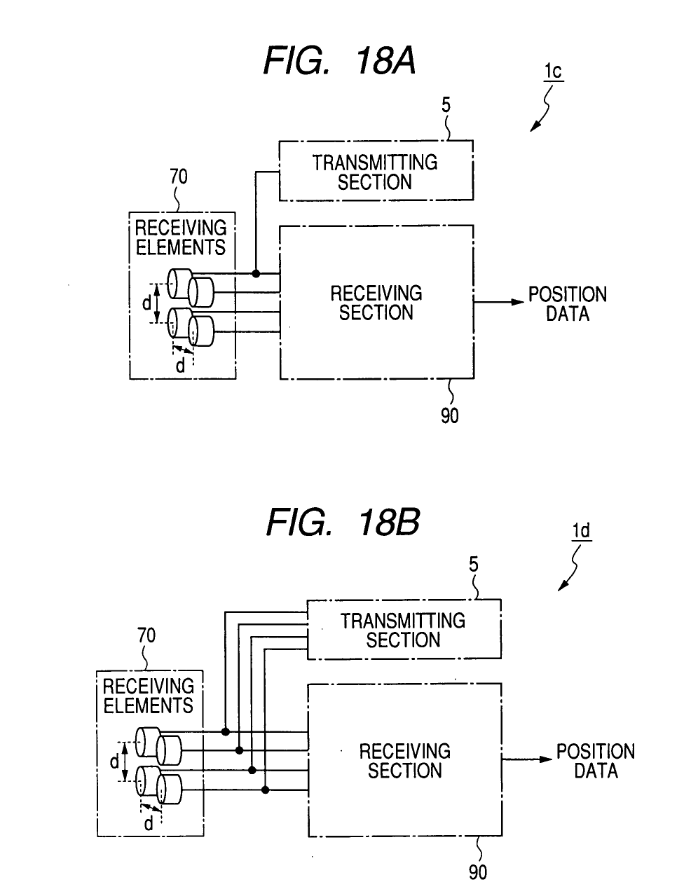

The invention is not limited to the above embodiments, and various alternative embodiments could be envisaged which fall within the scope claimed for the invention. For example, with the above embodiments, the receiver elements E1˜E4 and the transmitter element 3 are respectively separate units. However as shown in FIG. 18A, the apparatus could be configured as for the object detection apparatus 1b, with the transmitter element 3 being omitted and with the output of the transmitter section 5 being connected to one of the receiver elements E1˜E4 (in this example, to the receiver element E1), for supplying the transmission signal to that receiver element. Hence in this case, the receiver element E1 functions as both a transmitting and receiving element. With such a configuration, to prevent the transmission signal from being processed by the receiver section 90, it will be necessary to control the receiver section 90 to halt operation until emission of a burst of ultrasonic waves has been completed.

Alternatively as shown in FIG. 18B, it would be possible to supply transmission signals to each of the receiver elements E1˜E4 from the transmitter section 5, so that each of the receiver elements E1˜E4 functions as both a transmitting and receiving element. In particular, if the receiver elements E1˜E4 are utilized with the configuration of the receiver element array 7 described above, it would be possible to divide the receiver elements into two groups, allocated with respective transmission signals for emitting ultrasonic waves that are of inverse phase.

Moreover, alternative configurations are not limited to those shown in FIGS. 18A, 18B. For example, instead of utilizing four receiver elements E1˜E4, it would be possible to use only two receiver elements, or only three receiver elements.

Furthermore with the configurations shown in FIGS. 18A, 18B the transmission signals are directly applied along the same paths as the receiving signals. However, it would be equally possible to incorporate devices such as changeover switches or (in the case of electromagnetic waves being transmitted as the scanning waves) circulators, to separate the transmission signals and receiving signals.

Moreover with the above embodiments, the receiver elements E1˜E4 are located along the directions of sides of a square, i.e., with the horizontal and vertical directions used as a basis for defining a detected direction being oriented along these sides of the square. However it would be equally possible to orient the receiver elements such that the horizontal and vertical directions correspond with the diagonals of a square. In that case, the coordinates conversion section 47 in the receiver section 9 would operate in conjunction with the first candidate group generating section 25, instead of the second candidate direction group generating section 26.

Moreover with the above embodiments, the processing performed by the distance calculation section 23, the first candidate group generating section 25, the second candidate direction group generating section 26, the candidate direction group generating section 51, the hypothetical phase difference generating section 53, the direction determining sections 27, 55, and the position conversion section 29 can be performed by a combination of logic circuits. Alternatively, the successive processing operations can be performed by a program that is executed by a microcomputer. Such a program may be stored on a recording medium such as a portable recording medium, and loaded into the microcomputer from the recording medium when required to be used, or may be loaded into the microcomputer by being transferred via a data communication network.

Furthermore with the above embodiments, the hypothetical phase difference calculation section 64 utilizes the equation (20) to derive the hypothetical phase difference ΔΦexp, i.e., using a combination of the result values of equations (6), (7) and (11), or more specifically, a combination of the respective phase differences obtained for the receiver element pairs [E1, E2], [E2, E4], and [E2, E3] by the phase difference calculation sections 61, 62, 63. However the invention is not limited to the use of equation (20), and it would be possible to use other combinations of result values of the equations (6)˜(11) to calculate the hypothetical phase difference. If this is done, then it will be necessary to appropriately modify the phase difference calculation sections 61, 62, 63, to derive the requisite phase difference values ΔΦ_{i,j} from these.

Moreover, whereas both the candidate direction group generating section 51 and the hypothetical phase difference generating section 53 of the above embodiments each incorporate phase difference calculation sections, it would be possible for both of these to utilize a single set of phase difference calculation sections in common.

What is claimed is:

1. A method of detecting a direction of a target object based on received signals from a receiver element section which receives reflected waves comprising probe waves reflected from said target object, wherein said receiver section comprises an array of four receiver elements with at least three of said receiver elements located at respective apexes of a square, said square having a side length that is equal to or greater than half of a wavelength of said probe waves,
wherein said method comprises:
a first step (1a) of deriving a plurality of candidate directions each expressed as combination of an estimated azimuth angle and estimated altitude angle, each said candidate direction derived based on a phase difference between received signals from a first pair of said receiver elements respectively disposed on a first side of said square and a phase difference between received signals from a second pair of said receiver elements respectively disposed on a second side of said square at right angles to said first side;
a second step (2a) of selecting a specific one of said candidate directions based upon respective phase differences of a plurality of pairs of said receiver elements, with said plurality of pairs comprising at least one pair that differs from each of said pairs of receiver elements utilized in deriving said plurality of candidate directions, and
a third step (3a) of deriving said azimuth angle and said altitude angle of said target object based upon results of said selection performed in said second step (a2).

2. The method as claimed in claim 1, wherein said four receiver elements are respectively located at corresponding apexes of said square, and wherein designating said plurality of candidate directions derived in said first step (1a) as a first candidate direction group, said second step (2a) comprises
a first substep (21a) of deriving a second candidate direction group as a plurality of candidate directions each expressed as combination of an estimated azimuth angle and estimated altitude angle, with each said candidate direction derived based on a phase difference between received signals from a first pair of diagonally opposing ones of said receiver elements and a phase difference between received signals from a second pair of diagonally opposing ones of said receiver elements, said second pair being oriented at right angles to said first pair of diagonally opposing receiver elements,
a second substep (22a) of deriving a plurality of candidate direction-pairs each comprising a combination of two candidate directions respectively selected from said first candidate direction group and from said second candidate direction group, for all possible ones of said combinations, and calculating respective values of direction difference between said candidate directions constituting each of said candidate direction-pairs, and
a third substep (23a) selecting a one of said candidate direction-pairs for which said direction difference is a minimum.

3. The method according to claim 2, wherein said second substep (22a) comprises detecting a condition whereby there are none or a plurality of said candidate direction-pairs for which said direction difference is below a predetermined threshold value, and for determining that failure to detect a direction has occurred, when said condition is detected.

4. The method according to claim 1 wherein one of said four receiver elements is positioned, as a singular receiver element, at a location coplanar with said square, separated from each of respective sides of square and from respective extension lines of said sides, and wherein said second step comprises
a first substep of calculating a plurality of candidate judgment values respectively corresponding to said plurality of candidate directions that are derived in said first step, by successively inserting each of said candidate directions into a specific equation, said specific equation being adapted for deriving each said candidate judgment value as a hypothetical phase difference, comprising a phase difference between hypothetical reflected waves which are incident on a position of an empty one of said apexes of said square and reflected waves which are incident on said singular receiver element,
a second substep of calculating said hypothetical phase difference based on respective phase differences of a plurality of pairs of said receiver elements, with at least one of said plurality of pairs comprising said singular receiver element, and
a third substep of comparing each of said candidate judgment values with said hypothetical phase difference, and selecting a one of said candidate directions for which a difference between a corresponding candidate judgment value obtained in said first substep and said hypothetical phase difference obtained in said second substep is a minimum.

5. The method according to claim 4, wherein in said third substep comprises detecting a condition whereby there are none or a plurality of said candidate direction-pairs for which said direction difference obtained in said first substep is below a predetermined threshold value, and for determining that failure to detect a direction has occurred, when said condition is detected.

6. An object detection apparatus comprising
at least one transmitter element, and a transmitter circuit adapted to drive said transmitter element to emit probe waves,
a receiver element array comprising a plurality of receiver elements, and
a receiver circuit coupled to receive respective received signals from said receiver elements that result from reflection of said probe waves by a target object, and adapted to process said received signals for estimating a direction of said target object;
wherein:
at least three of said receiver elements are located at respective apexes of a square, said square having a side length that is equal to or greater than half of a wavelength of said probe waves,
and wherein said receiver circuit comprises
first candidate direction group calculation means adapted to derive a plurality of candidate directions each expressed as combination of an estimated azimuth angle and estimated altitude angle, with each of said candidate directions derived based on a phase difference between received signals from a first pair of said receiver elements respectively disposed on a first side of said square and a phase difference between received signals from a second pair of said receiver elements respectively disposed on a second side of said square at right angles to said first side;
candidate selection means, adapted to select a specific one of said candidate directions based upon respective phase differences of a plurality of pairs of said receiver elements, with said plurality of pairs comprising at least one pair that differs from each of said pairs of receiver elements utilized by said first candidate direction group calculation to derive said plurality of candidate directions, and
direction determination means adapted to derive said azimuth angle and said altitude angle of said target object direction based upon results of said selection performed by said candidate selection means.

7. An object detection apparatus as claimed in claim 1, wherein said four receiver elements are respectively located at corresponding ones of said apexes of said square, and wherein designating said plurality of candidate directions derived by said first candidate direction group calculation means as a first candidate direction group, wherein said candidate selection means comprises
second candidate direction group calculation means adapted to derive a second candidate direction group as a plurality of candidate directions each expressed as combination of an estimated azimuth angle and estimated altitude angle, with each said candidate direction derived based on a phase difference between received signals from a first pair of diagonally opposing ones of said receiver elements and a phase difference between received signals from a second pair of diagonally opposing ones of said receiver elements, said second pair being oriented at right angles to said first pair of diagonally opposing receiver elements,
direction difference calculation means, adapted to derive a plurality of candidate direction-pairs each comprising a combination of two candidate directions respectively selected from said first candidate direction group and from said second candidate direction group, for all possible ones of said combinations, and to calculate respective values of direction difference between said candidate directions constituting each of said candidate direction-pairs, and candidate direction-pair selection means, adapted to select a one of said candidate direction-pairs for which said direction difference is a minimum.

8. An object detection apparatus as claimed in claim 7, wherein said position detection means is adapted to detect a condition whereby there are none or a plurality of said candidate direction-pairs for which said direction difference is below a predetermined threshold value, and to determine that failure to detect a direction has occurred, when said condition is detected.

9. An object detection apparatus as claimed in claim 7, wherein said first candidate direction group calculation means is adapted to calculate an average value of a phase difference between a first pair of received signals and a phase difference between a second pair of received signals, with said first pair and second pair of received signals respectively corresponding to pairs of said receiver elements that are located on parallel sides of said square, and wherein said first candidate direction group calculation means is adapted to utilize said average value in deriving said plurality of candidate directions.

10. An object detection apparatus as claimed in claim 7, wherein said direction determination means is adapted to select a candidate direction that is from said first candidate direction group, from said candidate direction-pair that are selected by said candidate direction-pair selection means.

11. An object detection apparatus as claimed in claim 7, wherein said direction difference calculation means is adapted to detect when at least one of an azimuth angle and altitude angle that express a candidate direction derived by either of said first candidate direction group calculation means and said second candidate direction group calculation means is outside a half-angle of said array of receiver elements, and to exclude said candidate direction from said candidate direction-pairs.

12. An object detection apparatus as claimed in claim 6, wherein one of said four receiver elements is positioned, as a singular receiver element, at a location coplanar with said square, separated from each of respective sides of square and from respective extension lines of said sides, and wherein said apparatus comprises
candidate judgment value calculation means adapted to calculate a plurality of candidate judgment values respectively corresponding to said plurality of candidate directions that are derived by said first candidate direction group calculation means, by successively inserting values expressing each of said candidate directions into a predetermined equation, and to perform calculations utilizing said equation for deriving each said candidate judgment value as a hypothetical phase difference, comprising a difference between a phase of hypothetical reflected waves that are incident on a position of an empty one of said apexes of said square and a phase of reflected waves that are incident on said singular receiver element, hypothetical phase difference calculation means, adapted to calculate said hypothetical phase difference based on respective phase differences of a plurality of pairs of said receiver elements, with at least one of said plurality of pairs comprising said singular receiver element, and
candidate direction selection means, adapted to compare each of said candidate judgment values with said hypothetical phase difference obtained by said hypothetical phase difference calculation means, and to select a one of said candidate direction-pairs for which a difference between a corresponding candidate judgment value and said hypothetical phase difference obtained by said hypothetical phase difference calculation means is a minimum.

13. An object detection apparatus as claimed in claim 12, wherein said position determination means is adapted to detect a condition whereby there are none or a plurality of said candidate direction-pairs for which said direction difference obtained in said first substep is below a predetermined threshold value, and to determine that failure to detect a direction has occurred, when said condition is detected.

14. An object detection apparatus as claimed in claim 12, wherein a position of said singular receiver element in relationship to said empty apex of said square, as measured with respect to a x-axis direction and a y-axis direction that are respectively parallel to sides of said square oriented at right angles to one another, is set as an offset amount Dx along a direction parallel to said x-axis and an offset amount Dy parallel to said y-axis, and wherein said offset amounts Dx and Dy are predetermined as being respectively different values.

15. An object detection apparatus as claimed in claim 12, wherein said candidate judgment value calculation means is adapted to detect when at least one of an azimuth angle and altitude angle that express a candidate direction is outside a half-angle of said array of receiver elements, and to exclude said candidate direction from being an object of calculation.

16. An object detection apparatus as claimed in claim 6, wherein said direction determination means is adapted to detect a condition whereby at least one of said derived azimuth angle and altitude angle is outside a half-angle of said array of receiver elements and, when said condition is detected, to make a determination that no target object direction has been detected.

17. An object detection apparatus as claimed in claim 6, comprising distance calculation means adapted to calculate a distance between said array of receiver elements and said target object, based upon a time point of transmitting said probe waves and a subsequent time point of receiving resultant reflected waves from said target object.

18. An object detection apparatus as claimed in claim 17, wherein said probe waves comprise ultrasonic waves.

19. An object detection apparatus as claimed in claim 6, wherein at least one of said four receiver elements is also utilized as a transmitter element.

20. A computer program executed by a computer for performing each of said steps of the detection method claimed in claim 1.
